(19) United States
(12) Patent Application Publication
(10) Pub. No.: US 2026/0236710 A1
(43) Pub. Date: Aug. 13, 2026

(54) APPARATUSES, COMPUTER-IMPLEMENTED METHODS, AND COMPUTER PROGRAM PRODUCTS FOR GENERATIVE ARTIFICIAL INTELLIGENCE-BASED VEHICLE MAINTENANCE

(71) Applicant: HONEYWELL INTERNATIONAL INC., Charlotte, NC (US)

(72) Inventors: Mu LI, Beijing (CN); Bin DONG, Beijing (CN); Haotian QI, Beijing (CN)

(21) Appl. No.: 19/050,833

(22) Filed: Feb. 11, 2025

(51) Int. Cl. G06F 40/40; G06Q 10/20

(52) U.S. Cl. CPC G06F 40/40; G06Q 10/20

(57) ABSTRACT

Embodiments of the disclosure provide for improving vehicle maintenance efficiency and outcomes. In the context of a method, the method includes generating a first natural language instruction based on a natural language input indicative of at least one observed vehicle symptom; generating, via a large language model (LLM), at least one symptom of a vehicle condition based on the first natural language instruction; determining at least one of a corrective action or an assessment action for mitigating the vehicle condition based on the at least one symptom; generating a second natural language instruction based on the at least one symptom and the at least one of a corrective action or an assessment action; generating, via the LLM, a natural language output based on the second natural language instruction; and outputting the natural language output to at least one computing device.

### TECHNOLOGICAL FIELD

Embodiments of the present disclosure are generally directed to generative artificial intelligence (AI) techniques for assessing and correcting vehicle conditions.

### BACKGROUND

Typical approaches to diagnosing and mitigating vehicle conditions rely upon manual identification of keywords and self-navigation through maintenance interfaces. For example, a vehicle maintainer may utilize a search interface to index through predefined vehicle conditions and symptoms. However, such approaches may introduce inefficiency to maintenance processes due to the decisioning and selection workload placed upon users. Further, such approaches may fail to support a wide spectrum of observable vehicle symptoms. For example, existing maintenance interfaces typically constrain users to selecting between a set of predefined visual symptoms. In doing so, these approaches may fail to process and account for other observable symptoms, such as odors, tactile sensations, and auditory information. Additionally, existing approaches demonstrate limitations in the depth of maintenance explanation that is provided to users. For example, output of typical maintenance interfaces may be limited to simple citations to maintenance manuals and reference guides. As a result, vehicle maintainers may obtain an incomplete or narrow understanding of a vehicle condition, root cause, mitigation technique, and/or the like.

Applicant has discovered various technical problems associated with efficiently and accurately investigating and mitigating vehicle conditions. Through applied effort, ingenuity, and innovation, Applicant has solved many of these identified problems by developing the embodiments of the present disclosure, which are described in detail below.

### BRIEF SUMMARY

In general, embodiments of the present disclosure herein provide for assessing and mitigating vehicle conditions using generative AI techniques, such as large language models (LLMs). For example, embodiments of the present disclosure utilize an LLM to generate and augment descriptions of vehicle symptoms, and, in doing so, determine a condition being experienced by the vehicle (e.g., leak, broken component, improper setting, and/or the like). In various embodiments, the present methods, apparatuses, and computer program products determine a mitigation action based at least in part on the vehicle symptoms outputted by the LLM. For example, based at least in part on the LLM output, an assessment action for further investigating the vehicle condition and/or a corrective action for mitigating the vehicle condition may be determined. The present methods, apparatuses, and computer program products may further utilize the LLM to generate natural language outputs based at least in part on the vehicle symptoms, mitigations, and/or the like. In this manner, detailed descriptions of vehicle conditions, their root causes, and relevant mitigation actions may be outputted to vehicle maintainers. Additionally, novel mitigation actions may be generated by the LLM and presented to vehicle maintainers, vehicle administrators, and/or the like. Other implementations for LLM-directed vehicle maintenance will be, or will become, apparent to one with skill in the art upon examination of the following figures and detailed description. It is intended that all such additional implementations be included within this description be within the scope of the disclosure, and be protected by the following claims.

In accordance with a first aspect of the disclosure, a computer-implemented method for improved vehicle maintenance is provided. The computer-implemented method is executable utilizing any of a myriad of computing device(s) and/or combinations of hardware, software, firmware. In some example embodiments an example computer-implemented method includes generating a first natural language instruction based at least in part on a natural language input indicative of at least one observed vehicle symptom; generating, via a large language model (LLM), at least one symptom of a vehicle condition based at least in part on the first natural language instruction; determining at least one of a corrective action or an assessment action for mitigating the vehicle condition based at least in part on the at least one symptom; generating a second natural language instruction based at least in part on the at least one symptom and the at least one of the corrective action or the assessment action; generating, via the LLM, a natural language output based at least in part on the second natural language instruction; and outputting the natural language output to at least one computing device.

In some embodiments, the method further comprises generating the first natural language instruction further based at least in part on a first query framework associated with symptom identification; and generating the second natural language instruction further based at least in part on a second query framework associated with action identification. In some embodiments, the method further comprises outputting an utterance of the natural language output via a computer voice module of the at least one computing device. In some embodiments, the method further comprises causing rendering of a graphical user interface (GUI) on a display of the at least one computing device, the GUI comprising the natural language output. In some embodiments, the GUI further comprises the at least one symptom of the vehicle condition.

In some embodiments, the method further comprises obtaining an audio recording; and generating the natural language input based at least in part on the audio recording. In some embodiments, the method further comprises obtaining image data of a vehicle associated with the at least one observed vehicle symptom; and generating the first natural language instruction based at least in part on the image data. In some embodiments, the method further comprises generating a third natural language instruction based at least in part on a second natural language input indicative of a result of the assessment action; generating, via the LLM, a second symptom based at least in part on the third natural language instruction; and generating, via the LLM, a second natural language output based at least in part on a fourth natural language instruction comprising the at least one symptom and the second symptom, the second natural language output indicating a corrective action for mitigating the vehicle condition.

In some embodiments, the natural language output comprises the corrective action. In some embodiments, the method further comprises in response to receiving a second natural language input indicative of a failure of mitigation in implementation of the corrective action, provisioning to the at least one computing device an instruction to provide an additional natural language input indicative of the at least one observed vehicle symptom; generating a third natural language instruction based at least in part on the natural language output and an additional natural language input from the at least one computing device; generating, via the LLM, a new corrective action based at least in part on the third natural language instruction; provisioning the new corrective action to an administrator computing device; and in response to receiving an approval from the administrator computing device, outputting to the at least one computing device a second natural language output indicative of the new corrective action. In some embodiments, the method further comprises provisioning the new corrective action to a knowledge management environment to cause the knowledge management environment to update at least one fault model based at least in part on the new corrective action.

In some embodiments, the method further comprises obtaining, from the at least one computing device, feedback data indicative of a level of success in mitigation of the vehicle condition by implementation of the corrective action; and updating the LLM based at least in part on the feedback data. In some embodiments, the LLM is configured to generate a semantic representation of the at least one symptom of the vehicle condition. In some embodiments, the method further comprises determining the at least one of the corrective action or the assessment action based at least in part on the semantic representation. In some embodiments, the method further comprises receiving the natural language input from the at least one computing device via an application programming interface (API); and provisioning the natural language output to the at least one computing device via the API.

In some embodiments, the natural language output further comprises at least one root cause of the vehicle condition. In some embodiments, the method further comprises generating respective semantic representations of a plurality of historical vehicle maintenance records; generating a semantic representation of the natural language input; determining a subset of the plurality of historical vehicle maintenance records for which the respective semantic representation is within a threshold similarity of the semantic representation of the natural language input; and generating the first natural language instruction further based at least in part on the subset of the plurality of historical vehicle maintenance records. In some embodiments, the natural language output comprises the corrective action. In some embodiments, the corrective action indicates at least one vehicle component and a respective replacement procedure for the at least one vehicle component.

In some embodiments, the method further comprises obtaining feedback data from the at least one computing device, the feedback data being indicative of a level of success in mitigation of the vehicle condition by implementation of the corrective action; and provisioning the feedback data to a knowledge management environment. In some embodiments, the natural language output comprises at least one image generated by the LLM based at least in part on the at least one of the corrective action or the assessment action. In some embodiments, the method further comprises causing rendering of the image on a display of the at least one computing device.

In accordance with another aspect of the present disclosure, a computing apparatus for improved vehicle maintenance is provided. The computing apparatus in some embodiments includes at least one processor and at least one non-transitory memory, the at least non-transitory one memory having computer-coded instructions stored thereon. The computer-coded instructions in execution with the at least one processor causes the apparatus to perform any one of the example computer-implemented methods described herein. In some other embodiments, the computing apparatus includes means for performing each step of any of the computer-implemented methods described herein. In some embodiments, the vehicle comprises the apparatus.

In accordance with another aspect of the present disclosure, a computer program product for improved vehicle maintenance is provided. The computer program product in some embodiments includes at least one non-transitory computer-readable storage medium having computer program code stored thereon. The computer program code in execution with at least one processor is configured for performing any one of the example computer-implemented methods described herein.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a block diagram of a network environment that may be specially configured within which embodiments of the present disclosure may operate.

FIG. 2 illustrates a block diagram of an example apparatus that may be specially configured in accordance with at least some example embodiments of the present disclosure.

FIG. 3 illustrates an example data architecture in accordance with at least some example embodiments of the present disclosure.

FIG. 4 illustrates an example vehicle symptom and corrective action in accordance with at least some example embodiments of the present disclosure.

FIG. 5 illustrates an example workflow for performing vehicle maintenance via an LLM in accordance with at least some example embodiments of the present disclosure.

FIG. 6 illustrates an example workflow for updating a knowledge management environment in accordance with at least some example embodiments of the present disclosure.

FIG. 7 illustrates a flowchart depicting operations of an example process for performing conversational maintenance via an LLM in accordance with at least some example embodiments of the present disclosure.

FIG. 8 illustrates a graphical user interface (GUI) that may be rendered on a computing device in accordance with at least some example embodiments of the present disclosure.

FIG. 9 illustrates a GUI that may be rendered on a computing device in accordance with at least some example embodiments of the present disclosure.

FIG. 10 illustrates an example workflow for performing vehicle maintenance in accordance with existing approaches.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Overview

Embodiments of the present disclosure provide a myriad of technical advantages in the technical field of diagnosing and mitigating vehicle issues. Typically, vehicle maintenance diagnostics rely upon keyword searches. For example, a vehicle maintainer may observe a vehicle and select from a static list of keywords to record the observed symptom. However, such approaches may present too many or too few keywords to support efficient and accurate recordation of vehicle symptoms. For example, a shorter listing of keywords may reduce the decisioning time of a vehicle maintainer; however, the limited scope and depth of the listing may result in inability to match a maintainer's observation to a predefined category. As another example, a lengthier and more granular listing of keywords may increase the specificity of symptom recordation; however, vehicle maintainers may require greater decisioning times to manually parse through the many options and match an observation to a predefined category.

Further, such approaches may be limited to processing visual observations of vehicle issues (e.g., a leak is present, a sensor reading exceeds a threshold, a component is deformed). As a result, existing techniques may fail to account for auditory, tactile, and odor-based observations when determining and troubleshooting vehicle issues.

Embodiments of the present disclosure overcome the technical challenges of maintenance troubleshooting by leveraging generative AI models to provide an in-depth conversational experience by which vehicle maintainers may conduct maintenance investigations and determine mitigation actions. For example, the various embodiments of the present disclosure may generate symptoms indicative of vehicle conditions based at least in part on a large language model (LLM) and input comprising natural language text that describes a vehicle maintainer's observations of a vehicle. By enabling users to describe symptoms and observations using natural language text, the present techniques may increase the depth and accuracy of maintenance investigations and fault reports as compared to existing approaches that rely upon selection from a predefined list of issue categories. For example, the generative AI techniques may enable the present methods, apparatuses, and computer program products to address more complex symptom scenarios as compared to existing approaches.

The present methods, apparatuses, and computer program products may generate natural language instructions based at least in part on user inputs of natural language text. For example, a query framework may be applied to a natural language description of a user's visual, tactile, auditory, and odor-based observations of a vehicle issue to generate a natural language instruction. In such contexts, when inputted to an LLM, the natural language instruction may direct the LLM to generate one or more symptoms indicative of a vehicle condition based at least in part on the natural language text. In this manner, the methods, apparatuses, and computer program products may increase the efficiency of maintenance processes by enabling users to describe vehicle observations and issues in their own parlance as compared to existing approaches that rely upon selection between a set of keywords or categories. Additionally, the present techniques may mitigate instances where a user does not know the proper keyword for representing their observation.

In various embodiments, the methods, apparatuses, and computer program products determine one or more mitigation actions based at least in part on the symptoms, vehicle conditions, and/or the like that are generated by the LLM. For example, based at least in part on the symptoms and vehicle condition, the methods, apparatuses, and computer program products may determine one of a plurality of correction actions that is most likely to mitigate the vehicle condition. In some embodiments, the present techniques apply generative AI models to generate natural language outputs comprising explanations of vehicle conditions, root causes, symptoms, affected vehicle components and systems, symptoms, mitigation actions, and/or the like. In doing so, the techniques may provide more comprehensive and detailed troubleshooting outputs as compared to other approaches, which are typically limited to outputting a keyword or phrase embodying a recommended maintenance task.

For example, an existing approach may output a maintenance task comprising a single sentence (e.g., “replace the fuel pump and damaged fuel pump packings”). In contrast, the methods, apparatuses, and computer program products may output a multi-sentence explanation of the vehicle condition (e.g., fuel leak), root cause of the vehicle condition (e.g., fuel pump packing damage), observed symptoms, affected vehicle components, functionality of the vehicle components, procedures for performing a corrective action, and/or the like. In various embodiments, the methods, apparatuses, and computer program products enable users to provide additional user inputs that define follow-up questions, additional observations, results of mitigation actions, and/or the like. The present methods, apparatuses, and computer program products may apply generative AI models to the additional user input and conversation history to generate additional natural language outputs for addressing user questions, providing additional mitigation actions, and/or the like. In this manner, the present techniques may provide an automated, conversation-based troubleshooting experience that persists previous inputs and outputs to preserve and leverage the context of the conversations.

The present techniques may overcome disadvantages of manual, keyword-based approaches by providing an interactive, conversational interface for investigating and mitigating vehicle issues. Further, the present techniques may leverage generative AI models to generate and present new solutions for mitigating vehicle conditions. In addition, the described techniques may extend the capabilities of automated troubleshooting platforms such that auditory, tactile, and odor-based observations may be considered as inputs to assessing and troubleshooting vehicle conditions.

### Definitions

“Vehicle” refers to any apparatus that traverses throughout an environment by any mean of travel. In some contexts, a vehicle transports goods, persons, and/or the like, or traverses itself throughout an environment for any other purpose, by means of air, sea, or land. In some embodiments, a vehicle is ground-based, air-based, water-based, space-based (e.g., outer space or within an orbit of a planetary body, a natural satellite, or artificial satellite), and/or the like. In some embodiments, the vehicle is an aerial vehicle capable of air travel. Non-limiting examples of aerial vehicles include urban air mobility vehicles, drones, helicopters, fully autonomous air vehicles, semi-autonomous air vehicles, airplanes, orbital craft, spacecraft, and/or the like. In some embodiments, the vehicle is piloted by a human operator onboard the vehicle. For example, in an aerial context, the vehicle may be a commercial airliner operated by a flight crew. In some embodiments, the vehicle is remotely controllable such that a remote operator may initiate and direct movement of the vehicle. Additionally, in some embodiments, the vehicle is unmanned.

For example, the vehicle may be a powered, aerial vehicle that does not carry a human operator and is piloted by a remote operator using a control station. In some embodiments, the vehicle is an aquatic vehicle capable of surface or subsurface travel through and/or atop a liquid medium (e.g., water, water-ammonia solution, other water mixtures, and/or the like). Non-limiting examples of aquatic vehicles include unmanned underwater vehicles (UUVs), surface watercraft (e.g., boats, jet skis, and/or the like), amphibious watercraft, hovercraft, hydrofoil craft, and/or the like. As used herein, vehicle may refer to vehicles associated with advanced air mobility (AAM).

“AAM” refers to advanced air mobility, which includes all aerial vehicles and functions for aerial vehicles that are capable of performing vertical takeoff and/or vertical landing procedures. Non-limiting examples of AAM aerial vehicles include passenger transport vehicles, cargo transport vehicles, small package delivery vehicles, unmanned aerial system services, autonomous drone vehicles, and ground-piloted drone vehicles, where any such vehicle is capable of performing vertical takeoff and/or vertical landing.

“Generative artificial intelligence (AI) model” refers to any algorithmic and/or machine learning model that generates text, images, videos, or other data based at least in part on one or more instructions provided in a natural language format. In some embodiments, a generative AI model includes one or more large language models (LLMs) including autoregressive language models, autoencoding language models, and/or the like. Additionally, or alternatively, in some embodiments, a generative AI model comprises an architecture based at least in part on generative adversarial networks (GANs), variational autoencoders (VAEs), autoregressive models, recurrent neural networks (RNNs), transformers, image generators, and/or the like.

“Natural language” refers to textual information, or an utterance of textual information, intelligible to human users and in accordance with parlance of the human users. For example, natural language may comprise a body of textual content that defines a grammatically accurate and typographically correct series of phrases, sentences, paragraphs, and/or the like.

“Natural language input” refers to textual information that originates from one or more inputs of a human user. For example, natural language input may include textual content that is inputted by a user into a computing device. As another example, a natural language input may include recorded human speech based upon which textual information may be generated.

“Natural language instruction” refers to natural language text that requests a generative AI model to perform one or more tasks. For example, a natural language instruction may comprise natural language text that requests an LLM to generate a most likely vehicle symptom and condition based at least in part on a provided set of observations. As another example, a natural language instruction may comprise language text that requests the LLM to generate a description of a vehicle condition, root cause of the vehicle condition, and a corrective action for mitigating the vehicle condition based at least in part on a vehicle symptom, the corrective action, one or more observations of the vehicle, and/or the like.

“Natural language output” refers to natural language text that is generated by a generative AI model. For example, a natural language output may comprise output of an LLM.

In some embodiments, natural language output includes non-textual content outputted by a generative AI model. For example, natural language output may include natural language text generated by an LLM, and one or more images generated by an image generation model. As another example, natural language output may include utterances of natural language text, such as in the form of computer voice-based audio.

“Condition” refers to any non-optimal state that may be experienced by one or more components of a vehicle. In some embodiments, a condition includes instances of damage or wear to a vehicle component, malfunction of the vehicle component, a configuration or setting of the vehicle component, and/or the like. For example, a condition may include damage to a hydraulic line, malfunction of a sensor, unresponsiveness of one or more systems, and/or the like. In some embodiments, a condition is associated with one or more symptoms that represent phenomena which may be observed when the condition is present. For example, a condition of “damaged fuel pump and fuel pump packings” may be associated with symptoms of oil stains, fuel odor, emission of fuel from piping connections, and/or the like. As another example, a condition of “damaged hydraulic line” may be associated with symptoms of unresponsive flap controls, low hydraulic pressure, loss of hydraulic fluid volume, and/or the like.

### Example Systems and Apparatuses of the Disclosure

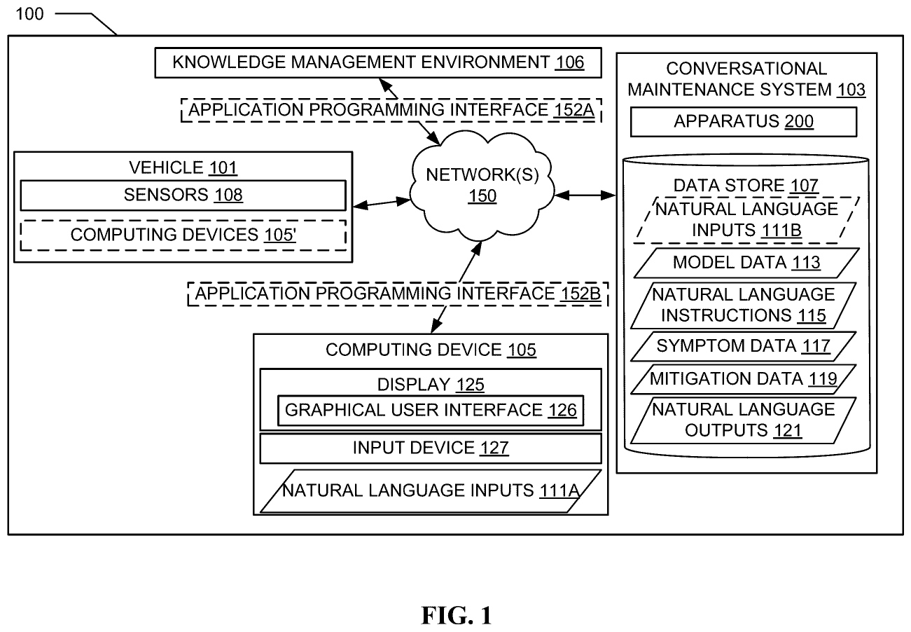

FIG. 1 illustrates a block diagram of a network environment that may be specially configured within which embodiments of the present disclosure may operate. Specifically, FIG. 1 depicts an example networked environment 100. As illustrated, the networked environment 100 includes one or more vehicles 101, a conversational maintenance system 103, one or more computing devices 105, a knowledge management environment 106, and/or the like. In some embodiments, the knowledge management environment 106 is external to the conversational maintenance system 103. Alternatively, in some embodiments, the conversational maintenance system 103 comprises the knowledge management environment 106.

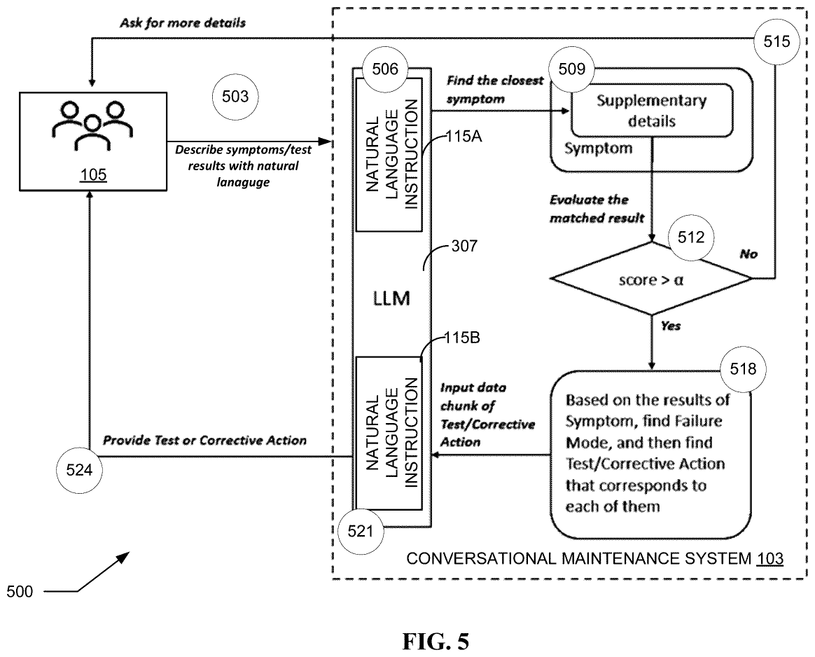

In some embodiments, the conversational maintenance system 103 includes an apparatus 200 configured to perform various functions and actions related to enacting techniques and processes described herein for generating vehicle symptoms, determining mitigation actions, and generating natural language outputs. For example, the conversational maintenance system 103 may prompt a trained LLM with a natural language instruction to cause the LLM to generate vehicle symptoms indicative of vehicle conditions. As another example, the conversational maintenance system 103 may prompt the LLM with a second natural language instruction generate a natural language output describing vehicle symptoms, root causes of vehicle conditions, corrective actions, mitigation actions, and/or the like. In various embodiments, the conversational maintenance system 103 is configured to perform the workflows and processes shown in the figures and described herein. For example, the conversational maintenance system 103 may be configured to perform the workflow 500, workflow 600, and process 700 as shown in FIGS. 5, 6, and 7, respectively, and described herein.

In some embodiments, the computing device 105 includes a personal computer, laptop, smartphone, tablet, phablet, Internet-of-Things enabled device, smart home device, virtual assistant, alarm system, workstation, work terminal, work portal, and/or the like. For example, the computing device 105 may embody a tablet utilized by a vehicle maintainer to access services and functionality of the conversational maintenance system 103. As another example, a vehicle 101 may include an onboard computing device 105′ by which a vehicle operator, technician, and/or the like perform vehicle troubleshooting via the conversational maintenance system 103. In some embodiments, the computing device 105 is configured to provision natural language inputs 111A to the conversational maintenance system 103. For example, the computing device 105 may provision text strings, audio recordings, and/or the like to the conversational maintenance system 103. Additionally, in some embodiments, the computing device 105 is configured to provision image data (e.g., photos, videos, scans, and/or the like) to the conversational maintenance system 103.

In some embodiments, the computing device 105 includes one or more displays 125 by which data corresponding to maintenance troubleshooting are displayed to a user of the computing device 105. For example, the display 125 may include renderings of graphical user interfaces (GUIs) 126 comprising natural language inputs, user instructions, natural language outputs (e.g., vehicle symptoms, mitigation actions, and explanations thereof), and/or the like. In some embodiments, the display 125 includes a CRT (cathode ray tube), LCD (liquid crystal display) monitor, LED (light-emitting diode) monitor, touchscreen monitor, and/or the like, for displaying information/data to a user of the computing device 105. In some embodiments, the computing device 105 includes one or more input devices 127 for receiving user inputs, such as selections for generating natural language inputs 111A. In some embodiments, the input device 127 includes one or more buttons, cursor devices, touch screens, including three-dimensional or pressure-based touch screens, camera, fingerprint scanners, accelerometer, retinal scanner, gyroscope, magnetometer, or other input devices.

In some embodiments, the computing device 105 includes a microphone configured to record utterances of a user and generate audio data based thereon. For example, the computing device 105 may be configured to generate audio data comprising spoken descriptions of vehicle observations. In some embodiments, the computing device 105 and/or apparatus 200 is/are configured to process audio data and generate natural language based at least in part on the audio data such that utterances of a user may be transcribed to a text format. In some embodiments, the computing device 105 includes one or more image capture systems configured to generate image data, such as photos, videos, scans, and/or the like. For example, via the image capture system, the computing device 105 may capture images of a vehicle 101, vehicle component, and/or the like, which may be inputted to a generative AI model to predict symptoms or a vehicle condition being displayed or experienced by the vehicle 101.

In some embodiments, the vehicle 101 includes one or more computing devices 105′. For example, the vehicle 101 may include a computing device 105′ by which a user aboard the vehicle may access services and functionality of the conversational maintenance system 103. In some embodiments, the vehicle 101 includes one or more sensors 108 configured to monitor components, systems, and processes of the vehicle 101. For example, the sensors 108 may include pressure sensors, temperature sensors, moisture sensors, conductance sensors, volume sensors, air quality sensors, image sensors, and/or the like. In various embodiments, the conversational maintenance system 103 is configured to obtain respective measurements generated by one or more sensors 108. For example, the conversational maintenance system 103 may obtain temperatures, pressures, volume levels, moisture levels, component settings, and/or the like from the sensors 108 and provide the measurements to an LLM for processing in accordance with a natural language instruction for generating vehicle symptoms.

In some embodiments, the knowledge management environment 106 is configured to store and organize historical vehicle maintenance records. A historical vehicle maintenance record may include any documentation, model, and/or the like that describes a vehicle 101, vehicle condition, vehicle symptom, mitigation action, and/or the like. For example, the knowledge management environment 106 may store plurality of historical vehicle maintenance records that describe a make, model, or type of vehicle 101, possible vehicle conditions that may be experienced by the vehicle 101, possible symptoms of the vehicle conditions, possible assessment actions for confirming the presence of a vehicle condition, possible corrective actions for mitigating a vehicle condition, and/or the like. Additionally, the historical vehicle maintenance records may include data by which the likelihood of success in implementation of a corrective action may be estimated. For example, the historical vehicle maintenance records may include feedback data indicative of whether implementation of a corrective action resulted in mitigation of a vehicle condition.

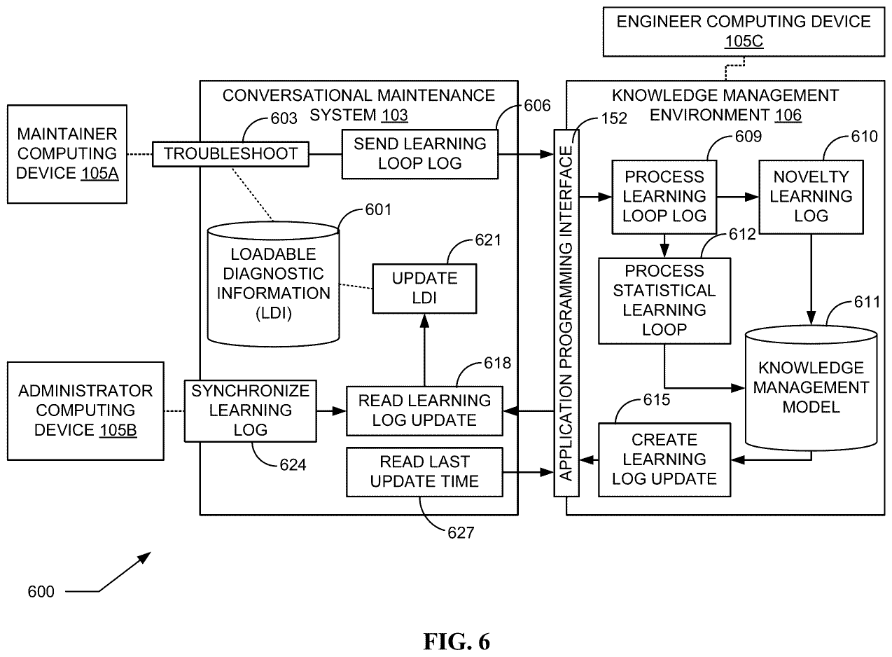

As used herein, a learning loop log may refer to a data object that comprises one or more historical vehicle maintenance records, feedback data, and/or the like. In various embodiments, the apparatus 200 is configured to obtain learning loop logs from the knowledge management environment 106. In doing so, the apparatus 200 may obtain one or more fault models by which mitigation actions may be determined. For example, as shown in FIG. 6, the apparatus 200 may obtain a fault model in the form of a database file referred to as loadable diagnostic information (LDI). In such contexts, the LDI may include a plurality of learning loop logs, which the apparatus 200 may utilize (e.g., in combination with natural language outputs of generative AI models) to determine mitigation actions for vehicle conditions. In various embodiments, the knowledge management environment 106 is configured to generate learning loop logs based at least in part on feedback data obtained from users. For example, the apparatus 200 may generate a statistical learning loop package based at least in part on feedback data that indicates a level of success in mitigating a vehicle condition by implementation of a corrective action. The apparatus 200 may provision the statistical learning loop package to a knowledge management environment 106. In doing so, the apparatus 200 may cause the knowledge management environment 106 to update one or more learning loop logs, fault models, and/or the like to adjust parameters for determining mitigation actions that are most likely to resolve a vehicle condition.

Additionally, or alternatively, in some embodiments, the knowledge management environment 106 is configured to generate novelty learning loop packages based at least in part on natural language outputs that define new corrective actions. For example, the apparatus 200 may provision to the knowledge management environment 106 a learning loop log comprising a new corrective action for mitigating a vehicle condition. In doing so, the apparatus 200 may cause the knowledge management environment to generate a novelty learning loop package based at least in part on the new corrective action. In some embodiments, the novelty learning loop package is provisioned to a computing device 105 for review and approval by an administrator. The apparatus 200 may receive from the computing device 105 (or the knowledge management environment 106 via relay) an indication of whether the new corrective action is approved for implementation. In response to approval, the apparatus 200 may receive an update to the LDI from the knowledge management environment 106, which may incorporate the new corrective action into fault models for the vehicle 101, vehicle condition, and/or the like. Further, the apparatus 200 may output the new corrective action to a computing device 105 of a vehicle maintainer.

In some embodiments, the conversational maintenance system 103 includes one or more data stores 107. The various data in the data store 107 may be accessible to one or more of the apparatus 200, the computing device 105, the knowledge management environment 106, the vehicle 101, and/or the like. The data store 107 may be representative of a plurality of data stores as can be appreciated. The data stored in the data store 107, for example, is associated with the operation of the various applications, apparatuses, and/or functional entities described herein. The data stored in the data store 107 may include, for example, natural language inputs 111B, model data 113, natural language instructions 115, symptom data 117, mitigation data 119, natural language outputs 121, and/or the like.

In some embodiments, natural language inputs 111A, 111B include natural language text provided by a user. For example, a natural language input 111A, 111B may include prose inputted to a computing device 105 by a vehicle maintainer, vehicle operator, and/or the like. In some embodiments, a natural language input 111A, 111B comprises (or is generated based at least in part on) an utterance. For example, a computing device 105 may record an utterance comprising spoken words, phrases, and/or the like of a user. In such contexts, a natural language input 111A, 111B comprising natural language text may be generated based at least in part on the recorded utterance. In some embodiments, a natural language input 111A, 111B is generated based at least in part on image data, such as one or more photos or videos of a user, vehicle 101, vehicle component, vehicle system, vehicle process, and/or the like.

In some embodiments, model data 112 includes data that defines one or more generative AI models. For example, the model data 112 may include data that defines one or more LLMs, LLM settings, and/or the like. In some embodiments, the model data 112 includes data for training a generative AI model to perform a task. For example, the model data 112 may include historical vehicle maintenance records comprising vehicle symptoms, vehicle conditions, root causes, mitigation actions, maintenance protocols, and/or the like. In such contexts, the data for training the generative AI model may further comprise historical outcomes of maintenance operations, such as results of implementing a corrective action. In some embodiments, model data 112 includes semantic representations of historical vehicle maintenance records, natural language inputs, and/or the like. A semantic representation may include one or more embeddings, such as a vector representation of natural language text, audio, image data, and/or the like.

In various embodiments, model data 112 includes query frameworks that may be utilized by the apparatus 200 to generate natural language instructions 115. In some embodiments, a query framework comprises predefined natural language for instructing a generative AI model to perform a task. The query framework may include one or more fields into which natural language inputs, historical vehicle maintenance records, and/or the like may be inserted such the generative AI model uses the inserted information as a basis for performing the instructed task. For example, a first query framework may be associated with symptom identification or symptom generation. The first query framework may comprise predefined language for requesting an LLM model to generate or identify a symptom of a vehicle condition, a root cause of the vehicle condition, and/or the like based at least in part on one or more input fields. In another example, a second query framework may be associated with vehicle condition mitigation, such as by identifying or generating actions that may mitigate the vehicle condition. The second query framework may comprise predefined language for requesting the model to perform action identification or action generation, such as by generating a description of a vehicle condition and an explanation of how to mitigate the mitigate the vehicle condition based at least in part on one or more input fields. In such contexts, the one or more input fields may be configured to receive natural language inputs describing observed vehicle symptoms, natural language outputs describing generated vehicle symptoms, historical vehicle maintenance records, and/or the like.

In some embodiments, natural language instructions 115 include model directives, requests, and/or the like that are generated by the apparatus 200 based at least in part on natural language inputs. For example, a natural language instruction 115 may comprise natural language text that instructs an LLM to perform symptom generation, describe a vehicle condition, explain a mitigation action, and/or the like. In some embodiments, symptom data 117 includes observed vehicle symptoms obtained from natural language inputs 111A, 111B and generated vehicle symptoms obtained from natural language outputs 121.

In some embodiments, symptom data 117 includes vehicle conditions and respective associations between vehicle conditions and vehicle symptoms. In some embodiments, symptom data 117 includes historical vehicle maintenance records obtained from a knowledge management environment 106. A historical vehicle maintenance record may include definitions of vehicle conditions including root causes, associated vehicle symptoms, historical and/or prescribed mitigation techniques, and/or the like. In some embodiments, symptom data 117 includes natural language inputs 111A, 111B that describe a user's observations of one or more vehicle symptoms.

In some embodiments, mitigation data 119 includes data associated with determining actions for assessing or correcting a vehicle condition (e.g., assessment actions and corrective actions, respectively). In some embodiments, mitigation data 119 includes data that defines mitigation actions including assessment actions, corrective actions, and/or the like. In some embodiments, the mitigation data 119 includes associations between vehicle conditions and mitigation actions. In some embodiments, the mitigation data 119 includes one or more fault models (also referred to herein as loadable diagnostic information) by which a mitigation action may be determined based at least in part on observed vehicle symptoms, generated vehicle symptoms, feedback data, and/or the like. In some embodiments, the fault models are obtained from a knowledge management environment 106. In some embodiments, the mitigation data 119 includes learning loops logs comprising new corrective actions, results of implemented corrective actions (e.g., based on feedback data from a computing device 105 or vehicle 101), and/or the like.

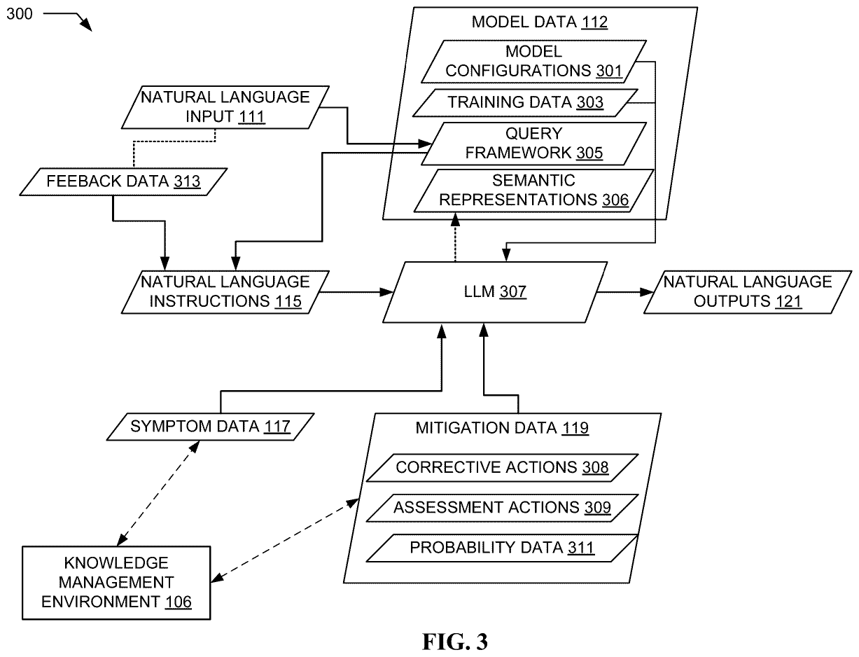

In some embodiments, natural language outputs 121 include data outputted by one or more generative AI model. For example, a natural language output 121 may include natural language text, image data, audio data, and/or the like, that was generated by an LLM based at least in part on a natural language input 111A, 111B. Additional example aspects of natural language inputs, model data 113, natural language instructions 115, symptom data 117, mitigation data 119, and natural language outputs 121, are shown in the data architecture 300 depicted in FIG. 3 and described herein.

In some embodiments, the apparatus 200 is configured to receive natural language inputs 111A from computing devices 105. For example, the apparatus 200 may receive natural language text, audio recordings, image data, and/or the like from computing devices 105. The natural language input 111A may indicate one or more observed vehicle symptoms (e.g., phenomena observed, heard, felt, or smelled by a vehicle maintainer). In some embodiments, the apparatus 200 is configured to generate natural language instruction 115 for symptom generation based at least in part on natural language inputs, query frameworks, and/or the like. For example, the apparatus 200 may generate a natural language instruction 115 configured to prompt an LLM to generate one or more vehicle symptoms indicative of a vehicle condition based at least in part on a natural language input. In this manner, the apparatus 200 may instruct the LLM to generate a vehicle condition and one or more vehicle symptoms indicative of the vehicle condition based at least in part on the natural language input provided by a vehicle maintainer, vehicle operator, and/or the like.

In some embodiments, the apparatus 200 is configured to generate natural language inputs in a text format based at least in part on audio recordings comprising utterances of natural language. In some embodiments, the apparatus 200 is configured to generate natural language descriptions of an image, video, and/or the like based at least in part on image data and one or more models configured to process and predict or classify contents of the image data. A natural language instruction 115 may include audio-derived natural language, image data-derived natural language, and/or the like. Additionally, or alternatively, in some embodiments, the natural language instruction 115 comprises audio recordings, image data, and/or the like, in a received format.

In some embodiments the apparatus 200 is configured to perform one or more retrieval augmentation generation (RAG) processes via the LLM and based at least in part on historical vehicle maintenance records obtained from a knowledge management environment 106. For example, the apparatus 200 may cause the LLM to generate semantic representations of natural language inputs and historical vehicle maintenance records to enable comparisons therebetween. Based at least in part on the comparisons, the apparatus 200 may determine a subset of the historical vehicle maintenance records that are within a threshold similarity of the natural language input. The apparatus 200 may update a natural language instruction to include or reference the subset of historical vehicle maintenance record such that the LLM is instructed to generate a natural language output 121 based on both the natural language input and the subset of historical vehicle maintenance records.

In some embodiments, the apparatus 200 is configured to determine one or more mitigation actions based at least in part on a natural language output 121. For example, an LLM may generate a natural language output 121 comprising a plurality of vehicle symptoms indicative of a vehicle condition. The apparatus 200 may determine, based at least in part on the natural language output 121, one of a plurality of corrective actions that is most likely to result in successful mitigation of the vehicle condition. Additionally, or alternatively, the apparatus 200 may determine one or more assessment actions by which additional details of the vehicle 101, vehicle symptoms, vehicle condition, and/or the like may be obtained to improve subsequent determinations of optimal corrective actions. In various embodiments, the apparatus 200 is configured to generate probability scores for the mitigation actions based at least in part on the natural language output and one or more fault models of the vehicle condition, vehicle 101, and/or the like. A probability score may indicate a level of likelihood that the mitigation action will mitigate the vehicle condition (e.g., eliminate the vehicle condition, reduce the impact of the vehicle condition in accordance with predetermined criteria, and/or the like).

In some embodiments, the apparatus 200 is configured to generate a second natural language instruction 115 for vehicle condition mitigation based at least in part on mitigation data 119 including the determined mitigation action, natural language outputs 121 (e.g., generated vehicle symptoms, vehicle conditions, root causes, affected components), natural language inputs (e.g., observed vehicle symptoms), symptom data 117 and/or the like. The second natural language instruction 115 may be generated based at least in part on a query framework for vehicle condition mitigation. The apparatus 200 may prompt the LLM to generate a natural language output 121 comprising a description of the vehicle condition, symptoms, root cause, and mitigation action.

In some embodiments, the apparatus 200 is configured to output natural language outputs 121 to a computing device 105. For example, the apparatus 200 may cause renderings of GUI 126 on a display 125 of the computing device 105. As another example, the apparatus 200 may provision natural language outputs 121 to the computing device. In another example, the apparatus 200 may generate (or cause the computing device 105 to generate) utterances of natural language outputs 121 via a computer voice module such that the natural language outputs 121 may be audibly outputted to a user. In some embodiments, the apparatus 200 is configured to output images, videos, and/or the like based at least in part on natural language outputs 121. For example, the apparatus 200 may output images of vehicle components, videos of maintenance procedures, and/or the like, which may be retrieved from memory or obtained as an output of a generative AI model.

In some embodiments, the apparatus 200 is configured to obtain natural language inputs indicative of a result of a mitigation action. In such contexts, the natural language may be referred to as feedback data. For example, the apparatus 200 may receive from the computing device 105 natural language text describing a level of success in mitigation of the vehicle condition via implementation of a corrective action. As another example, the apparatus 200 may receive natural language text describing a result of an assessment action, which may include additional observations of a vehicle 101 or phenomena occurring therein. In various embodiments, the apparatus 200 is configured to generate additional natural language outputs 121 based at least in part on the feedback data and determine additional mitigation actions based at least in part on the additional natural language outputs 121.

In some embodiments, the apparatus 200 is configured to generate a new corrective action, assessment action, and/or the like via the LLM. For example, the apparatus 200 may generate a natural language instruction based at least in part on one or more vehicle systems, condition root causes, corrective action results, assessment action results, and/or the like. The apparatus 200 may prompt the LLM with the natural language instruction to cause the LLM to generate a new corrective action for mitigating a vehicle condition, which may have been unsuccessfully mitigated by implementation of a previously determined corrective action. In some embodiments, a computing device 105 associated with an administrator is configured to provide approval or disapproval of a new corrective action to the apparatus 200. For example, the apparatus 200 may be configured to provision a natural language output comprising the new corrective action to a computing device 105 associated with an administrator. In response to receiving approval from the computing device 105 of the administrator (e.g., via user input selection, and/or the like), the apparatus 200 may provision the natural language output to a computing device 105 associated with a vehicle maintainer. Additionally, or alternatively, the apparatus 200 may provision the new corrective action, associated vehicle symptoms, vehicle condition, natural language inputs, and/or the like to a knowledge management environment 106.

In some embodiments, the vehicle 101, apparatus 200, computing device 105, knowledge management environment 106, and/or the like, are communicable over one or more communications network(s), for example the communications network(s) 150. It should be appreciated that the communications network 150 in some embodiments is embodied in any of a myriad of network configurations. In some embodiments, the communications network 150 embodies a public network (e.g., the Internet). In some embodiments, the communications network 150 embodies a private network (e.g., an internal, localized, and/or closed-off network between particular devices). In some other embodiments, the communications network 150 embodies a hybrid network (e.g., a network enabling internal communications between particular connected devices and external communications with other devices). In some embodiments, the communications network 150 embodies a satellite-based communication network. Additionally, or alternatively, in some embodiments, the communications network 150 embodies a radio-based communication network that enables communication between the apparatus 200, vehicle 101, computing device 105, knowledge management environment 106, and/or the like.

The communications network 150 in some embodiments may include one or more transponders, satellites, base station(s), relay(s), router(s), switch(es), cell tower(s), communications cable(s) and/or associated routing station(s), and/or the like. In some embodiments, the communications network 150 includes one or more user-controlled computing device(s) (e.g., a user owner router and/or modem) and/or one or more external utility devices (e.g., Internet service provider communication tower(s) and/or other device(s)). In some embodiments, the network 150 includes one or more application programming interfaces (APIs) that enable intercommunication between elements of the networked environment 100. For example, the conversational maintenance system 103 may provision data to and obtain data from the knowledge management environment 106 via the network 150 and an API 152A. As another example, the conversational maintenance system 103 may provision data to and obtain data from the computing device via the network 150 and an API 152B.

Each of the components of the system communicatively coupled to transmit data to and/or receive data from one another over the same or different wireless or wired networks embodying the communications network 150. Such configuration(s) include, without limitation, a wired or wireless Personal Area Network (PAN), Local Area Network (LAN), Metropolitan Area Network (MAN), Wide Area Network (WAN), satellite network, radio network, and/or the like. Additionally, while FIG. 1 illustrate certain system entities as separate, standalone entities communicating over the communications network 150, the various embodiments are not limited to this particular architecture. In other embodiments, one or more computing entities share one or more components, hardware, and/or the like, or otherwise are embodied by a single computing device such that connection(s) between the computing entities are over the communications network 150 are altered and/or rendered unnecessary.

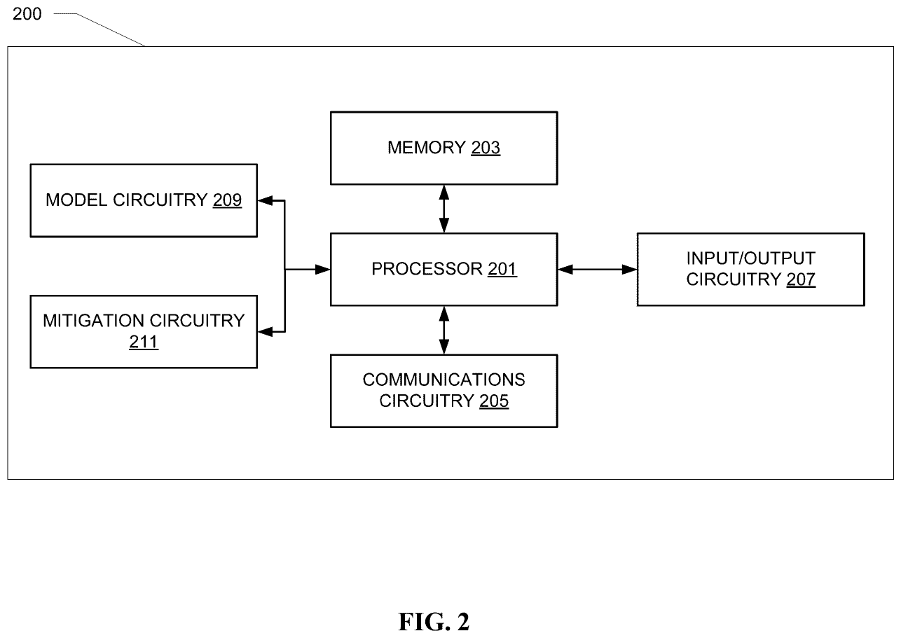

FIG. 2 illustrates a block diagram of an example apparatus 200 that may be specially configured in accordance with at least some example embodiments of the present disclosure. The apparatus 200 may carry out functionality and processes described herein to generate natural language instructions, generate vehicle symptoms, determine corrective or assessment actions, generate natural language outputs, communicate with computing devices 105, and/or the like. In some embodiments, the apparatus 200 includes a processor 201, memory 203, communications circuitry 205, input/output circuitry 207, model circuitry 209, and mitigation circuitry 211. In some embodiments, the apparatus 200 is configured, using one or more of the processor 201, memory 203, communications circuitry 205, input/output circuitry 207, model circuitry 209, and/or mitigation circuitry 211, to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, controlling, modifying, restoring, processing, displaying, storing, determining, creating/generating, predicting, monitoring, evaluating, comparing, and/or similar terms used herein interchangeably. In one embodiment, these functions, operations, and/or processes may be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Additionally, or alternatively, in some embodiments, other elements of the apparatus 200 provide or supplement the functionality of another particular set of circuitry. For example, the processor 201 in some embodiments provides processing functionality to any of the sets of circuitry, the memory 203 provides storage functionality to any of the sets of circuitry, the communications circuitry 205 provides network interface functionality to any of the sets of circuitry, and/or the like.

In some embodiments, the processor 201 (and/or co-processor or any other processing circuitry assisting or otherwise associated with the processor) is/are in communication with the memory 203 via a bus for passing information among components of the apparatus 200. In some embodiments, for example, the memory 203 is non-transitory and may include, for example, one or more volatile and/or non-volatile memories. In other words, for example, the memory 203 in some embodiments includes or embodies an electronic storage device (e.g., a computer readable storage medium). In some embodiments, the memory 203 is configured to store information, data, content, applications, instructions, or the like, for enabling the apparatus 200 to carry out various functions in accordance with example embodiments of the present disclosure (e.g., generating power metrics, difference values, alignment correction data, and/or the like). In some embodiments, the memory 203 is embodied as a data store 107 as shown in FIG. 1 and described herein. In some embodiments, the memory 203 includes natural language inputs 111, model data 113, natural language instructions symptom data 117, mitigation data 119, natural language outputs 121, and/or the like, as further architected in FIG. 3 and described herein.

The processor 201 may be embodied in a number of different ways. For example, in some embodiments, the processor 201 includes one or more processing devices configured to perform independently. Additionally, or alternatively, in some embodiments, the processor 201 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 201 is configured to execute instructions stored in the memory 203 or otherwise accessible to the processor. Additionally, or alternatively, the processor 201 in some embodiments is configured to execute hard-coded functionality. As such, whether configured by hardware or software methods, or by a combination thereof, the processor 201 represents an entity (e.g., physically embodied in circuitry) capable of performing operations according to an embodiment of the present disclosure while configured accordingly. Additionally, or alternatively, as another example in some example embodiments, when the processor 201 is embodied as an executor of software instructions, the instructions specifically configure the processor 201 to perform the algorithms embodied in the specific operations described herein when such instructions are executed.

As one particular example embodiment, the processor 201 is configured to perform various operations associated with diagnosing and mitigation vehicle conditions via generative AI models, such as LLMs. In some embodiments, the processor 201 includes hardware, software, firmware, and/or the like, that generate natural language instructions based at least in part on natural language input, prior generated natural language outputs, vehicle symptoms, mitigation actions, and/or the like. For example, the processor 201 may generate a natural language instruction that requests an LLM to generate a most likely symptom and vehicle condition based at least in part on a natural language input describing observations of the vehicle. As another example, the processor 201 may generate a natural language instruction that requests the LLM to generate a natural language output based at least in part on a vehicle condition, set of observations, determined mitigation actions, and/or the like. As another example, the processor 201 may generate natural language inputs based at least in part on an audio recording of a user, such as vehicle maintainer, vehicle operator, and/or the like.

In some embodiments, the apparatus 200 includes input/output circuitry 207 that provides output to a user and, in some embodiments, receives an indication of a user input. For example, in some contexts, the input/output circuitry 207 provides output to and receives input from computing devices of one or more vehicle maintainers, administrators, vehicle operators, and/or the like. In some embodiments, the input/output circuitry 207 is in communication with the processor 201 to provide such functionality. The input/output circuitry 207 may comprise one or more user interface(s) and in some embodiments includes a display that comprises the interface(s) rendered as a web user interface, an application user interface, a user device, a backend system, or the like. In some embodiments, the input/output circuitry 207 also includes a keyboard, a mouse, a joystick, a touch screen, touch areas, soft keys a microphone, a speaker, and/or other input/output mechanisms. The processor 201 and/or input/output circuitry 207 comprising the processor may be configured to control one or more functions of one or more user interface elements through computer program instructions (e.g., software and/or firmware) stored on a memory accessible to the processor 201 (e.g., memory 203, and/or the like). In some embodiments, the input/output circuitry 207 includes or utilizes a user-facing application to provide input/output functionality to a display of a computing device 105, vehicle 101, and/or other display associated with a user. In various embodiments, the input/output circuitry 207 includes one or more computer voice modules configured to generate utterances of natural language outputs. In some embodiments, the input/output circuitry 207 is configured to cause rendering of GUIs on a display of a computing device to enable provision and receipt of data to and from the computing device.

In some embodiments, the apparatus 200 includes communications circuitry 205. The communications circuitry 205 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 205 includes, for example, a network interface for enabling communications with a wired or wireless communications network, such as the network 150 shown in FIG. 1 and described herein.

Additionally, or alternatively in some embodiments, the communications circuitry 205 includes one or more network interface card(s), antenna(s), bus(es), switch(es), router(s), modem(s), and supporting hardware, firmware, and/or software, or any other device suitable for enabling communications via one or more communications network(s). Additionally, or alternatively, the communications circuitry 205 includes circuitry for interacting with the antenna(s) and/or other hardware or software to cause transmission of signals via the antenna(s) or to handle receipt of signals received via the antenna(s). In some embodiments, the communications circuitry 205 enables transmission to and/or receipt of data from a vehicle 101, computing device 105, knowledge management environment 106, and/or other external computing devices in communication with the apparatus 200.

The model circuitry 209 includes hardware, software, firmware, and/or a combination thereof, that carry out processes for generating, updating, provisioning natural language instructions to, and obtaining natural language outputs from generative AI models. For example, in some contexts, the model circuitry 209 includes hardware, software, firmware, and/or the like, that prompt an LLM with a natural language instruction to generate, as output, one or more vehicle symptoms, vehicle conditions, and/or the like, based at least in part on a natural language input comprising observations of a vehicle. As another example, the model circuitry 209 includes hardware, software, firmware, and/or the like, that prompt the LLM with a second natural language instruction to generate a natural language output comprising a description of a vehicle condition (e.g., symptoms, root causes, and/or the like), a corrective action for mitigating the vehicle condition, an assessment action for further investigating the vehicle condition, and/or the like. In another example, the model circuitry 209 may prompt an LLM to generate a new corrective action or generate an updated set of vehicle symptoms, vehicle conditions, and/or the like based at least in part on results of a corrective action, assessment action, and/or the like.

In some embodiments, the model circuitry 209 is configured to communicate with a knowledge management environment 106 to report, improve, and expand LLM performance. For example, the model circuitry 209 may provision to the knowledge management environment 106 one or more learning loop packages configured to update likelihood of success of existing corrective actions, provide AI-generated corrective actions, and/or the like. In some embodiments, the model circuitry 209 includes a separate processor, specially configured field programmable gate array (FPGA), and/or a specially programmed application specific integrated circuit (ASIC).

The mitigation circuitry 211 includes hardware, software, firmware, and/or a combination thereof, that carry out processes for determining mitigation actions (e.g., corrective actions, assessment actions, and/or the like) based at least in part on natural language output from one or more generative AI models. For example, in some contexts, the mitigation circuitry 211 includes hardware, software, firmware, and/or the like, that determine one of a plurality of corrective actions that is most likely to mitigate a vehicle issue based at least in part on a natural language output comprising a description, semantic representation, and/or embedding of the vehicle condition, vehicle symptoms, and/or the like. In some embodiments, the mitigation circuitry 211 includes hardware, software, firmware, and/or the like, that obtain feedback data from computing devices 105, where the feedback data indicates a result of an assessment action, level of success in implementing a corrective action, and/or the like. In some embodiments, the mitigation circuitry 211 is configured to communicate with a computing device 105 of an administrator to determine whether a new corrective action may be approved for outputting to a user. In some embodiments, the mitigation circuitry 211 includes a separate processor, specially configured field programmable gate array (FPGA), and/or a specially programmed application specific integrated circuit (ASIC).

Additionally, or alternatively, in some embodiments, two or more of the processor 201, memory 203, communications circuitry 205, input/output circuitry 207, model circuitry 209, and/or mitigation circuitry 211 are combinable. Additionally, or alternatively, in some embodiments, one or more of the sets of circuitry perform some or all of the functionality described associated with another component. For example, in some embodiments, two or more of the sets of circuitry 201-211 are combined into a single module embodied in hardware, software, firmware, and/or a combination thereof. Similarly, in some embodiments, one or more of the sets of circuitry, for example the memory 203, communication circuitry 205, model circuitry 209, and/or mitigation circuitry 211 is/are combined with the processor 201, such that the processor 201 performs one or more of the operations described above with respect to each of these sets of circuitry 203-211.

### Example Data Architecture and Data Flows of the Disclosure

Having described example systems and apparatuses in accordance with embodiments of the present disclosure, example architectures and flows of data in accordance with the present disclosure will now be discussed. In some embodiments, the systems and/or apparatuses described herein maintain data environment(s) that enable the workflows in accordance with the data architectures described herein. For example, in some embodiments, the systems and/or apparatuses described herein function in accordance with the data architectures depicted and described herein with respect to FIG. 3, which may be maintained via the apparatus 200.

FIG. 3. illustrates an example data architecture 300 in accordance with at least some example embodiments of the present disclosure. In some embodiments, a natural language input 111 and a query framework 305 are used to generate a natural language instruction 115. For example, a query framework 305 may embody a template for a natural language instruction 115, including a predetermined task such as “describe a symptom of a vehicle condition based on . . . ,” “describe a mitigation action based on . . . ,” “explain a vehicle condition based on . . . ,” and/or the like. The query framework 305 may include fields that may populated with natural language input 111 to generate the natural language instruction 115. In some embodiments, a natural language instruction 115 may be generated based at least in part on feedback data 313. The feedback data 313 may comprise one or more natural language inputs 111 that describe a result of a mitigation action, such as an outcome of an assessment action or an effect of a corrective action.

In some embodiments, a large language model (LLM) 307 is generated based at least in part on one or more model configurations 301, training data 303, and/or the like. The model configuration 301 may define operations and processes by which the LLM 307 represents or tokenizes natural language inputs and generates semantic representations 306 (e.g., embeddings of natural language text). In some embodiments, the model configuration 301 defines one or more attention mechanisms for analyzing tokenize natural language inputs, embeddings, and/or the like. In some embodiments, the model configuration 301 defines feed forward functions, output encodings, and/or the like by which natural language outputs may be generated via the LLM 307. In some embodiments, the model configuration 301 defines one or more settings of the LLM 307 including parameter count, training objectives, maximum input length, randomness (e.g., temperature), nucleus sampling (e.g., Top P), context window size, stop sequence, frequency penalty, presence penalty, and/or the like. In some embodiments, the training data 303 includes historical vehicle maintenance records indicative of historical vehicle conditions, symptoms observed in accordance with the conditions, mitigation actions performed responsive to the conditions, and/or the like. The training data 303 may further include results of the mitigation actions, such as levels of success in mitigating a vehicle condition.

In some embodiments, the symptom data 117, mitigation data 119, training data 303, and/or the like are provided by a knowledge management environment 106. In some embodiments, the conversational maintenance system 103 obtains the symptom data 117, mitigation data 119, training data 303, and/or the like in the form of one or more fault models (also referred to herein as loadable diagnostic information (LDI)). The symptom data 117, mitigation data 119, training data 303, and/or the like may be updated based at least in part on learning loop log updates received from the knowledge management environment 106.

In some embodiments, the symptom data 117 includes one or more corpuses of information that document and describe vehicle symptoms and vehicle conditions that may be associated with vehicle symptoms. For example, the symptom data 117 may include historical vehicle maintenance records comprising details of symptoms observed in prior occurrences of vehicle conditions and performances of maintenance troubleshooting. The symptom data 117 may include descriptions of visual, auditory, tactile, or odor-based criteria by which a vehicle condition may be detected. In some embodiments, the symptom data 117 includes sensor measurements that may be associated with presence of a vehicle condition. In some embodiments, the symptom data 117 includes photos, videos, audio recordings, and/or the like of vehicle symptoms.

In some embodiments, the mitigation data 119 includes data that defines possible corrective actions 308, assessment actions 309, and/or the like for mitigating a vehicle condition. In some embodiments, the mitigation data 119 includes probability data 311 by which the likelihood of success of a mitigation action may be predicted. For example, the probability data 311 may include a plurality of probability scores for a set of corrective actions 308 in accordance with mitigation of a vehicle condition. In some embodiments, the mitigation data 119, symptom data 117, and/or the like includes predetermined thresholds for determining matches (e.g., threshold-satisfying similarity) between respective semantic representations of historical vehicle maintenance records and natural language inputs 111, natural language outputs121, and/or the like.

In some embodiments, a natural language output 121 is generated the LLM based at least in part on the natural language instruction 115, symptom data 117, mitigation data 119, and/or the like. In some embodiments, the present methods, apparatuses, and computer program products perform RAG processes to augment natural language instructions 115 based on subsets historical vehicle maintenance records (e.g., from symptom data 117, mitigation data, and/or the like) that demonstrate similarity to a natural language input 111, prior generated natural language output, and/or the like). In some embodiments, the natural language output 121 comprises a new corrective action. In such contexts, the new corrective action may be provisioned to the knowledge management environment 106, administrator computing devices 105, and/or the like for approval. In response to approval of the new corrective action, the symptom data 117, mitigation data 119, and/or the like may be updated based on a learning loop log update from the knowledge management environment 106. Additionally, in some embodiments, the probability data 311 may be updated based at least in part on a learning loop log update that is generated by the knowledge management environment 106 based at least in part on feedback data 313.

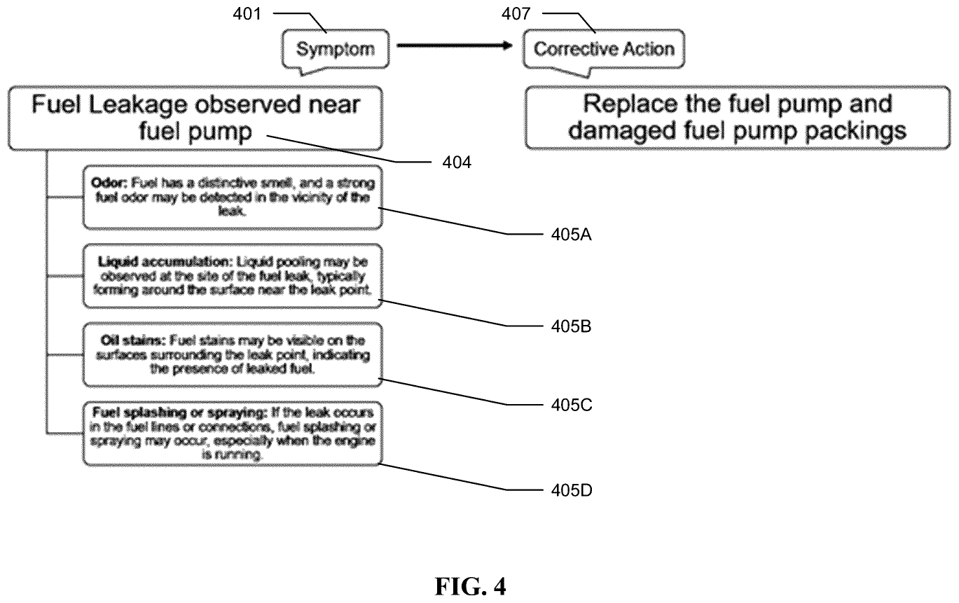

FIG. 4 illustrates an example vehicle symptom 401 and corrective action 403. In some embodiments, the symptom 401 is generated by the conversational maintenance system 103 via an LLM. For example, the conversational maintenance system 103 may receive a natural language input describing a user's observations of a fuel pump and liquid accumulated around the fuel pump. The conversational maintenance system 103 may generate a natural language instruction for symptom generation based at least in part on the natural language input describing the observed vehicle symptoms. Based at least in part on the natural language instruction, the LLM may generate a natural language output describing a vehicle symptom 401 and, in some embodiments, one or more affected vehicle components 404. For example, the natural language output may comprise a vehicle symptom of “fuel leakage observed near fuel pump.” In some embodiments, the vehicle symptom 401 includes additional parameters 405A-D of the vehicle symptom 401, which are described in natural language text generated by the LLM. The additional parameters 405A-D may increase the specificity and depth of information by which mitigation actions are determined and described to a user. For example, the additional parameters 405A-D may include odor-based parameters for assessing a fuel leakage (e.g., “fuel has a distinctive smell, and a strong fuel odor may be detected in the vicinity of a leak”). As another example, the additional parameters 405A-D may include odor-based parameters for assessing the fuel leakage, such as descriptions of liquid accumulation, oil stains, fuel splashing, and/or the like, that may be observed to determine a root cause of the vehicle condition.

In various embodiments, the conversational maintenance system 103 determines a corrective action 407 based at least in part on the vehicle condition and generated vehicle symptom 401 (e.g., including the affected vehicle component 404 and parameters 405A-D). For example, the conversational maintenance system 103 may determine that a corrective action of replacing the fuel pump and damaged fuel pump packings is most likely to result in mitigation of the fuel leakage. Alternatively, or additionally, the conversational maintenance system 103 may determine one or more assessment actions for further investigating the vehicle condition or vehicle symptom 401, such as inspecting a plurality of fuel lines connected to the fuel pump to identify a subset of fuel lines that leak when the engine of the vehicle is running. As described herein, the conversational maintenance system may provision natural language outputs describing the symptom 401, vehicle condition, corrective action 407, and/or the like to users, such as vehicle maintainers, vehicle operators, administrators, system engineers, and/or the like.

FIG. 5 illustrates an example workflow 500 for performing vehicle maintenance via an LLM in accordance with at least some example embodiments of the present disclosure. In some embodiments, via a computing device 105, a user may input to the conversational maintenance system 103 one or more observed symptoms described in natural language (indicium 503). The conversational maintenance system 103 may generate a natural language instruction 115A based at least in part on the inputted natural language and prompt an LLM 307 with the natural language instruction 115A (indicium 506). In some embodiments, the LLM 307 analyzes the natural language and generates keywords, semantic representations, and/or the like of vehicle symptoms, an associated vehicle condition, a root cause of the vehicle condition, an affected vehicle element, and/or the like.

In some embodiments, the conversational maintenance system 103 searches one or more databases of supplementary symptom details to determine one or more closest matching symptom details based at least in part on the natural language output of the LLM 307 (indicium 509). In some embodiments, the conversational maintenance system 103 ranks a plurality of predefined symptom details based at least in part on a similarity score generated by comparing the predefined symptom detail to the natural language output. The conversational maintenance system 103 may determine whether a top-ranked entry satisfies a predetermined threshold (indicium 512). In response to determining that the top-ranked entry satisfies the predetermined threshold, the conversational maintenance system 103 may confirm that the user is observing and describing the top-ranked symptom detail. The conversational maintenance system 103 may generate and execute a query (e.g., a structured query language (SQL) query, and/or the like) to determine a predefined symptom that is associated with the top-ranked symptom detail. Alternatively, in response to determining that the top-ranked entry does not satisfy the predetermined threshold, the conversational maintenance system 103 may provision to the computing device 105 an instruction to provide additional details, such as additional observations of the vehicle or ongoing scenario (indicium 515).

In some embodiments, the conversational maintenance system 103 determines a vehicle condition (also referred to as a fault condition) based at least in part on the natural language output, matched symptom detail, a predefined symptom associated with the matched symptom detail, and/or the like. In various embodiments, based at least in part on the vehicle condition, the conversational maintenance system 103 determines one or more assessment actions, corrective actions, and/or the like (indicium 518). In some embodiments, the conversational maintenance system 103 generates and prompts the LLM 307 with a second natural language instruction 115B based at least in part on the corrective action, assessment action, vehicle condition, natural language output, vehicle symptom, vehicle condition, and/or the like (indicium 521). The LLM 307 may generate a natural language output based at least in part on the second natural language instruction 115B. The natural language output may include a narrative that describes the vehicle condition and symptoms, explains the corrective action or mitigation action, and/or the like. The conversational maintenance system 103 may output the natural language output to the computing device 105 of the user (indicium 524). In some embodiments, in instances where a user is prompted to submit additional details, the workflow 500 may be repeated to generate additional natural language output and determine one or more predefined symptom details that are within a threshold similarity of the natural language output.

In some embodiments, the conversational maintenance system 103 receives feedback data indicative of results of an assessment action, corrective action, and/or the like. The workflow 500 may be suspended in response to the conversational maintenance system 103 receiving an indication that the vehicle condition was mitigated via implementation of a corrective action. In response to an indication that the vehicle condition persists (e.g., the corrective action failed to mitigate the vehicle condition), the workflow 500 may be repeated. In repetitions of the workflow 500, the conversational maintenance system 103 may request additional details, assessment action results, and/or the like from the user.

In some embodiments, the conversational maintenance system 103 prompts the LLM 307 to generate a new corrective action for mitigating the vehicle condition in response to a failure to mitigate the vehicle condition following performance of a threshold quantity of corrective actions, assessment actions, and/or the like (e.g., 2, 3, 5, or another suitable value, which may be configured by an administrator, vehicle owner, manufacture, operator, and/or the like). The conversational maintenance system 103 may provision the new corrective action to a computing device 105 of an administrator, system engineer, and/or the like for review and approval. In response to obtaining approval of the new corrective action, the conversational maintenance system 103 may output the new corrective action (or a natural language output describing the new corrective action) to the computing device 105 of the user. Additionally, the conversational maintenance system 103 may provision the new corrective action to a knowledge management environment 106. In doing so, the conversational maintenance system 103 may cause the knowledge management environment 106 to update loadable diagnostic information embodying one or more fault models.

FIG. 6 illustrates an example workflow 600 for updating a knowledge management environment 106. In various embodiments, the workflow 600 enables optimization of generative AI models, fault models, and/or the like by obtaining feedback data and iteratively refining and updating the model during usage. In this manner, the conversational maintenance system 103 may perform the workflow 600 enable a self-reinforcing learning process. In some embodiments, feedback data is provisioned by the conversational maintenance system 103 to the knowledge management environment 106 in the form of log packages (also referred to as “learning loop logs”). For example, the conversational maintenance system 103 may perform workflows and processes described herein to provide conversational maintenance troubleshooting to maintainer computing devices 105A (indicium 503). In some embodiments, the conversational maintenance system 103 generates and sends a learning loop log to the knowledge management environment 106 via an API 152.

In various embodiments, the learning loop log is generated based at least in part on feedback data, natural language output of one or more generative AI models, and/or the like. In some embodiments, a statistical learning loop log is generated based at least in part on feedback data that indicates a result of implementing a corrective action, such as a level of success in mitigating a vehicle condition by implementing a corrective action. The statistical learning loop log may be utilized by the knowledge management environment 106 to update a knowledge management model 611 that is used to predict corrective actions that are most likely to mitigate a vehicle condition (indicia 609 and 612). In some embodiments, a novelty learning log is generated based at least in part on a new corrective action that is not present in the knowledge management model 611, LDI 601 (e.g., fault model used by the conversational maintenance system 103), and/or the like (indicia 609 and 610). The new corrective action may be obtained from natural language generated by a generative AI model, such as an LLM.

In some embodiments, the provision of a learning loop log to the knowledge management environment 106 causes the knowledge management environment 106 to update a knowledge management model 611 and generate a learning log update based at least in part on the received learning loop log (indicium 615). The conversational maintenance system 103 may receive the learning log update from the knowledge management environment via an API 152. In some embodiments, the conversational maintenance system 103 reads the learning log update and updates the LDI 601 (indicia 618 and 621). In some embodiments, the learning log update, or content thereof, is provisioned to an administrator computing device 105B, engineer computing device 105C, and/or the like to enable an administrator or engineer to review and approve a new corrective action (indicium 624). In response to approval of the new corrective action, the conversational maintenance system 103 may update the LDI 601 based at least in part on the learning log update. In some embodiments, the knowledge management environment 106 is configured to obtain data associated with resolved queries from the conversational maintenance system 103. The knowledge management environment 106, conversational maintenance system 103, and/or the like may update the knowledge management environment 106 based at least in part on the obtained data. In some embodiments the conversational maintenance system 103 is configured to push learning log updates to the knowledge management environment 106 (indicium 627). In doing so the conversational maintenance system 103 may ensure new corrective actions and adjustments to likelihood ratings of existing corrective actions are captured in the LDI 601. Additionally, or alternatively, in some embodiments, the conversational maintenance system 103 may receive learning log updates from the knowledge management environment 106.

### Example Processes of the Disclosure

Having described example systems and apparatuses, data architectures, and data flows in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

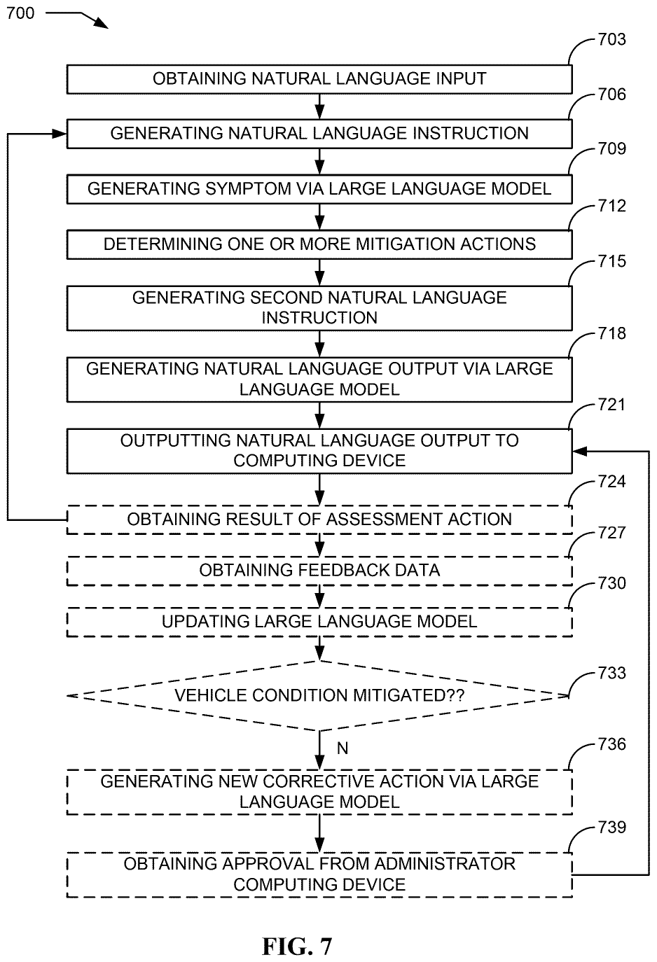

FIG. 7 illustrates a flowchart depicting operations of an example process 700 for performing conversational maintenance via an LLM in accordance with at least some example embodiments of the present disclosure. In some embodiments, the process 700 is embodied by computer program code stored on a non-transitory computer-readable storage medium of a computer program product configured for execution to perform the process as depicted and described. Additionally, or alternatively, in some embodiments, the process 700 is performed by one or more specially configured computing devices, such as apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 203 and/or another component depicted and/or described herein and/or otherwise accessible to the apparatus 200, for performing the operations as depicted and described.

In some embodiments, the apparatus 200 is in communication with one or more internal or external apparatus(es), system(s), device(s), and/or the like, to perform one or more of the operations as depicted and described. For example, the apparatus 200 may communicate with one or more vehicles 101, computing devices 105, knowledge management environments 106, and/or the like to perform one or more operations of the process 700.

At operation 703, the apparatus 200 includes means such as the model circuitry 209, the mitigation circuitry 211, the communications circuitry 205, the input/output circuitry 207, the processor 201, and/or the like, or a combination thereof, that obtain a natural language input. For example, the apparatus 200 may obtain a natural language input from a computing device 105. In various embodiments, the natural language input is indicative of one or more observed vehicle symptoms. For example, the natural language input may comprise a plurality of text strings (e.g., sentences, phrases, and/or the like) that describe observations of a vehicle maintainer, including visual observations, auditory observations, tactile observations, odor-based observations, and/or the like. In some embodiments, the natural language input indicates one or more vehicle components, vehicle systems, vehicle processes, and/or the like. In some embodiments, the natural language input indicates a vehicle type, vehicle model, vehicle identifier, and/or the like, based upon which the vehicle 101 may be identified. In some embodiments, the natural language input includes user-generated queries. For example, the natural language input may include queries of “what should I do,” “which components should be replaced,” “what is the service procedure,” “who is the technician responsible,” and/or the like. In some embodiments, the natural language input comprises measurements generated by one or more sensors aboard the vehicle 101. For example, the natural language input may include measurements of temperature, pressure, flow rate, volume, moisture level, and/or the like.

In some embodiments, the apparatus 200 causes rendering of a GUI on a display 125 of the computing device 105. The GUI may include a user input field configured for receiving user inputs that define natural language text. The GUI may include one or more rendered instructions that direct the vehicle maintainer (or other user) to initiate a conversation describing their observations, issues, and/or the like. In some embodiments, in response to receiving natural language input, the apparatus 200 is configured to identify the associated vehicle 101. In doing so, the apparatus 200 may obtain fault models, generative AI models, sensor data, and/or the like that is/are associated with the vehicle 101.

In some embodiments, obtaining the natural language input comprises obtaining one or more audio recordings. For example, the apparatus 200 may receive an audio recording from the computing device 105, vehicle 101, and/or the like. The audio recording may comprise utterances of natural language from vehicle maintainer, and the natural language may describe observed vehicle symptoms (e.g., sights, smells, tactile sensations, sounds, and/or the like). The apparatus 200 may generate natural language input of a textual format based at least in part on the audio recording and one or more natural language processing algorithms, models, and/or the like. In doing so, the apparatus 200 may enable the vehicle maintainer to provide natural language input without requiring the vehicle maintainer to observe a display of the computing device 105 or physically manipulate an input device.

In some embodiments, obtaining the natural language input comprises obtaining image data from the computing device, vehicle 101, and/or the like. For example, the apparatus 200 may receive an image, video, and/or the like that was generated by an image capture system of the computing device 105 or image sensor of the vehicle 101. The image data may comprise photos, videos, and/or the like of vehicle components, vehicle operations, and/or the like. The apparatus 200 may process the image data via one or more image recognition algorithms, generative AI models, and/or the like to generate natural language text describing the contents of the image. For example, based at least in part on the image and via an LLM, the apparatus 200 may generate natural language text describing one or more vehicle components within the image, one or more statuses of the vehicle component (e.g., worn, broken, disconnected, functioning), and/or the like.

At operation 706, the apparatus 200 includes means such as the model circuitry 209, the mitigation circuitry 211, the communications circuitry 205, the input/output circuitry 207, the processor 201, and/or the like, or a combination thereof, that generate a natural language instruction based at least in part on the natural language input. For example, the apparatus 200 may generate a natural language instruction for determining one or more symptoms indicative of a vehicle condition based at least in part on the natural language input of operation 703. In some embodiments, the apparatus 200 generates the natural language instruction based at least in part on a query framework associated with symptom generation. For example, the apparatus 200 may populate a query framework based at least in part on the natural language input to generate a natural language instruction. In such contexts, the natural language instruction may comprise natural language text that requests an LLM to generate one or more symptoms indicative of a vehicle condition based at least in part on the observations represented by the natural language input.

In some embodiments, the apparatus 200 causes the LLM to perform one or more retrieval-augmented generation (RAG) processes such that the LLM generate a natural language output based at least in part on the natural language input and at least a subset of historical vehicle maintenance records that demonstrate relevance to the natural language input, vehicle 101, and/or the like. For example, the apparatus 200 may cause the LLM to generate respective semantic representations of a plurality of historical vehicle maintenance records (e.g., retrieved from a data store 107 or obtained from a knowledge management environment 106). A semantic representation may include one or more vector-based embeddings of the contents of the historical vehicle maintenance record.

In some embodiments, the apparatus 200 causes the LLM to generate a semantic representation of the natural language input. In some embodiments, the apparatus 200 compares the semantic representation of the natural language input and the semantic representations of the historical vehicle maintenance records. For example, the apparatus 200 may generate respective similarity scores (e.g., cosine similarity, L² norm, Euclidean distance, and/or the like) between the semantic representation of the natural language input and the semantic representations of the historical vehicle maintenance records. In some embodiments, based at least in part on the similarity scores, the apparatus 200 determines a subset of the historical vehicle maintenance records for which the respective semantic representation is within a threshold similarity of the semantic representation of the natural language input. In various embodiments, the apparatus 200 augments the natural language instruction based at least in part on the subset of historical vehicle maintenance records. For example, the apparatus 200 may modify the natural language instruction to direct the LLM to generate vehicle symptoms indicative of a vehicle condition based at least in part on the natural language input and, further, based at least in part on the subset of historical vehicle maintenance records. In this manner, the apparatus 200 may enable the LLM to utilize domain-specific, externally grounded data as a basis for generating natural language outputs.

At operation 709, the apparatus 200 includes means such as the model circuitry 209, the mitigation circuitry 211, the communications circuitry 205, the input/output circuitry 207, the processor 201, and/or the like, or a combination thereof, that generate, via an LLM, one or more symptoms indicative of a vehicle condition based at least in part on the natural language instruction. For example, the apparatus 200 may prompt the LLM based at least in part on the natural language instruction to cause the LLM to generate a natural language output comprising one or more vehicle symptoms of a condition that the vehicle may be experiencing. In some embodiments, the natural language output further comprises a root cause of the vehicle condition, one or more vehicle components, vehicle systems, vehicle processes, and/or the like that are affected by the vehicle condition or associated symptoms. In some embodiments, the apparatus 200 outputs the natural language output of operation 709 to the computing device 105. For example, the apparatus 200 may update a GUI on a display of the computing device 105 to include one or more generated vehicle symptoms, a vehicle condition, and/or the like. Additionally, or alternatively, in some embodiments, the apparatus 200 may generate an utterance of the natural language output via a computer voice module. In such contexts, the apparatus 200 may cause output of the artificial utterance via one or more audio sources of the computing device 105, vehicle 101, and/or the like. In doing so, the apparatus 200 may enable the vehicle maintainer to access and comprehend the natural language output without requiring the vehicle maintainer to observe a display of the computing device 105.

At operation 712, the apparatus 200 includes means such as the model circuitry 209, the mitigation circuitry 211, the communications circuitry 205, the input/output circuitry 207, the processor 201, and/or the like, or a combination thereof, that determine one or more mitigation actions based at least in part on the natural language output generated by the LLM. For example, the apparatus 200 may determine one or more corrective actions, assessment actions, and/or the like based at least in part on the one or more vehicle symptoms, vehicle conditions, and/or the like generated by the LLM. Additionally, the apparatus 200 may determine a root cause of the vehicle condition, one or more impacted vehicle components, processes, or systems, one or more tools, techniques, or parts associated with performing a mitigation actions, one or more protocols for performing a mitigation action, and/or the like.

In some embodiments, the apparatus 200 is configured to generate a respective probability score for a plurality of corrective actions based at least in part on the natural language output of the LLM. A probability score may indicate a level likelihood that implementation of the corrective action will mitigate the vehicle condition associated with the generated symptoms. In some embodiments, the apparatus 200 obtains the corrective actions and generates the probability scores based at least in part on one or more fault models, which may be retrieved from the data store 107 or obtained from a knowledge management environment 106. In some embodiments, the apparatus 200 generates a ranking of the plurality of corrective actions based at least in part on the respective probability scores. The apparatus 200 may compare the similarity score of a top-ranked corrective action to a predetermined threshold. In response to determining that the similarity score satisfies the predetermined threshold, the apparatus 200 may determine that the corrective action is a suitable candidate for implementation.

In some embodiments, in response to determining that no corrective actions demonstrate a threshold-satisfying probability score, the apparatus 200 determines one or more assessment actions that may be performed to obtain additional observations and details of the vehicle condition, symptoms, and/or the like. Alternatively, in some embodiments, the apparatus 200 scores and ranks assessment actions in combination with the corrective actions such that an assessment action may be determined as a next step of mitigating the vehicle condition (e.g., instead of a corrective action). In some embodiments, in response to determining that no corrective actions demonstrate a threshold-satisfying probability score, the apparatus 200 prompts the LLM to generate a new corrective action, assessment action, and/or the like (see operation 736).

Additionally, or alternatively, in some embodiments, response to determining that no corrective actions demonstrate a threshold-satisfying probability score, the apparatus 200 outputs to the computing device 105 an instruction to provide additional natural language input indicative of the vehicle condition, symptoms, and/or the like. For example, the apparatus 200 may update a GUI to include a rendered instruction requesting additional details. In some embodiments, via the LLM, the apparatus 200 generates one or more user-directed queries that request additional information on an aspect of a vehicle, vehicle observation, and/or the like. For example, the apparatus 200 may cause the LLM to generate a user-directed query based at least in part on a natural language instruction comprising the vehicle condition, generated vehicle symptoms, observed vehicle symptoms (e.g., in the form of one or more natural language inputs), and/or the like. The natural language instruction may request the LLM to determine what additional details, observations, and/or the like may be provided by the vehicle maintainer to improve determination of appropriate mitigation actions.

At operation 715, the apparatus 200 includes means such as the model circuitry 209, the mitigation circuitry 211, the communications circuitry 205, the input/output circuitry 207, the processor 201, and/or the like, or a combination thereof, that generate a second natural language instruction based at least in part on the one or more mitigation actions, vehicle symptoms, vehicle conditions, natural language input, and/or the like. For example, based at least in part on the data obtained at operations 703, 709, 712, and/or the like, the apparatus 200 may generate a second natural language instruction that requests the LLM to generate a narrative that describes the vehicle condition (e.g., including explaining a root cause and the impacted vehicle components and systems within the context of the generated vehicle symptoms). The apparatus 200 may generate the second natural language instruction at least in part by populating a second query framework associated with vehicle condition mitigation. For example, the apparatus 200 may generate the second natural language instruction based at least in part on applying a query framework to the determined mitigation action, generated vehicle symptoms, vehicle condition, root cause, and/or the like. In some embodiments, the apparatus 200 causes the LLM to perform one or more RAG processes to augment the second natural language instruction based at least in part one on or more historical vehicle records.

At operation 718, the apparatus 200 includes means such as the model circuitry 209, the mitigation circuitry 211, the communications circuitry 205, the input/output circuitry 207, the processor 201, and/or the like, or a combination thereof, that generate, via the LLM, a natural language output based at least in part on the second natural language instruction. For example, the apparatus 200 may prompt the LLM to generate a natural language output based at least in part on the natural language instruction. The natural language output may include a natural language text that describes the generated vehicle symptoms, observed vehicle symptoms, and/or the like in the context of the vehicle condition, a root cause of the vehicle condition, one or more affected vehicle components, systems, or processes, and/or the like.

In various embodiments, the natural language output includes text, images, and/or the like that describe one or more mitigation actions (e.g., assessment actions, corrective actions, and/or the like). In some embodiments, the natural language output describes one or more vehicle components for replacement or investigation in accordance with a corrective action, assessment action, and/or the like. In some embodiments, the natural language output includes one or more citations to procedures for performing a mitigation action. In some embodiments a citation includes a digital reference (e.g., a web address, folder path, and/or the like) by which a procedure may be accessed via the computing device 105. For example, the natural language output may indicate an affected vehicle component, a replacement vehicle component, and a digital reference to a replacement procedure for the affected vehicle component. In some embodiments, the natural language output comprises one or more images generated by the LLM or obtained by the LLM from a vehicle maintenance record. For example, the natural language output may comprise a diagram of a vehicle system, an image of an affected vehicle component, and/or the like.

At operation 721, the apparatus 200 includes means such as the model circuitry 209, the mitigation circuitry 211, the communications circuitry 205, the input/output circuitry 207, the processor 201, and/or the like, or a combination thereof, that output the natural language output to one or more computing devices. For example, the apparatus 200 may cause outputting of the natural language output to the computing device 105 from which the natural language input was received. In some embodiments, the apparatus 200 causes rendering of the natural language output within a GUI displayed on the computing device 105. For example, the apparatus 200 may update a GUI to include natural language text, images, and/or the like that describe one or more mitigation actions, the vehicle condition, a root cause of the vehicle condition, observed vehicle symptoms, generated vehicle symptoms, affected vehicle components, and/or the like.

In some embodiments, the apparatus 200 generates an utterance of the natural language output via a computer voice module, and/or the like. In doing so, the apparatus 200 may enable a vehicle maintainer to access the natural language output without requiring the vehicle maintainer to observe a display of the computing device 105. The apparatus 200 may provision the utterance to the computing device 105 in the form of an audio file to cause the computing device to output the utterance via one or more audio sources. Alternatively, the apparatus 200 may upload the audio file to a digital environment by which the computing device 105 may access and stream the utterance of the natural language output. In some embodiments, the apparatus 200 provisions the natural language output to the computing device 105 and, in doing so, causes the computing device 105 to generate and output an utterance of the natural language output via an installed computer voice module.

At operation 724, the apparatus 200 optionally includes means such as the model circuitry 209, the mitigation circuitry 211, the communications circuitry 205, the input/output circuitry 207, the processor 201, and/or the like, or a combination thereof, that obtain a result of an assessment action. For example, the apparatus 200 may obtain from the computing device 105 a natural language input that indicate a result of an assessment action outputted to the computing device 105 at operation 721. In some embodiments, in response to obtaining an outcome of an assessment action, the process 700 proceeds to operation 706. For example, the apparatus 200 may generate an additional natural language instruction based at least in part on the result of the assessment action and one or more prior generated natural language instructions, natural language outputs, and/or the like. The additional natural language instruction may instruct the LLM to generate additional vehicle symptoms, root causes, and/or the like based at least in part on the assessment action. The process 700 may further proceed to operations 709-721 by which the apparatus 200 may determine an additional mitigation action and generate additional natural language output that may be provided to a user.

At operation 727, the apparatus 200 optionally includes means such as the model circuitry 209, the mitigation circuitry 211, the communications circuitry 205, the input/output circuitry 207, the processor 201, and/or the like, or a combination thereof, that obtain feedback data indicative of a level of success in implementation of a corrective action. For example, the apparatus 200 may obtain from the computing device 105 one or more user inputs that indicate an effect or result of implementing the corrective action on mitigation of the vehicle condition.

At operation 730, the apparatus 200 optionally includes means such as the model circuitry 209, the mitigation circuitry 211, the communications circuitry 205, the input/output circuitry 207, the processor 201, and/or the like, or a combination thereof, that update the LLM based at least in part on the feedback data. For example, the apparatus 200 may update the LLM based at least in part on an indication of failure or success in mitigation of the vehicle condition by implementation of the corrective action. Additionally, or alternatively, in some embodiments, the apparatus 200 provisions feedback data to a knowledge management environment 106.

At operation 733, the apparatus 200 optionally includes means such as the model circuitry 209, the mitigation circuitry 211, the communications circuitry 205, the input/output circuitry 207, the processor 201, and/or the like, or a combination thereof, that determine whether the vehicle condition was mitigated by implementation of a corrective action. For example, the apparatus 200 may determine whether implementation of a corrective action resulted in mitigation of the vehicle condition. In some embodiments, the apparatus 200 receives from the computing device 105 feedback data indicative of a level of success in mitigating the vehicle condition via performance of the corrective action. For example, a vehicle maintainer may provide to the computing device 105 one or more user inputs describing a result of the corrective action. In such contexts, the apparatus 200 may receive from the computing device 105 feedback data generated based at least in part on the user inputs. In some embodiments, the feedback data includes image data, such as an image capture or video of a vehicle component, system, and/or the like that is associated with the vehicle condition, one or more associated symptoms, and/or the like. The apparatus 200 may determine a level of success of the corrective action based at least in part on the image data, natural language input describing the image data, and/or the like.

In various embodiments, in response to the apparatus 200 determining that the vehicle condition was not mitigated by the corrective action, the process 700 may proceed to operation 736. For example, the process 700 may proceed to operation 736 in response to the apparatus 200 receiving a second natural language input indicative of a failure of mitigation in implementation of the corrective action. In some embodiments, in response to determining that the corrective action failed to mitigate the vehicle condition, the apparatus 200 provisions to the computing device 105 an instruction to provide an additional natural language input describing observations of the vehicle condition, vehicle symptoms, and/or the like. In doing so, the apparatus 200 may obtain additional natural language inputs for processing via the LLM. In this manner, the apparatus 200 may progress a conversation to capture greater details around maintenance issues and augment troubleshooting operations. In various embodiments, in response to determining that the corrective action mitigated the vehicle condition, the apparatus 200 may generate and provision to a knowledge management environment 106 a statistical learning loop package configured to indicate that the corrective action was successful in mitigating the vehicle issue. In this manner, the apparatus 200 may augment conversational maintenance operations with additional data indicative of the likelihood that a vehicle condition may be mitigated by a corrective action.

At operation 736, the apparatus 200 optionally includes means such as the model circuitry 209, the mitigation circuitry 211, the communications circuitry 205, the input/output circuitry 207, the processor 201, and/or the like, or a combination thereof, that generate a new corrective action via the LLM. For example, via the LLM, the apparatus 200 may generate a natural language output indicative of a novel corrective action for mitigating the vehicle condition. In some embodiments, the apparatus 200 applies a query framework to the vehicle condition, vehicle symptoms, feedback data, one or more failed corrective actions, and/or the like to generate a natural language instruction for requesting a new corrective action. The apparatus 200 may generate the new corrective action based at least in part on the natural language instruction and the LLM. Additionally, or alternatively, in some embodiments, the apparatus 200 may instruct the LLM to generate a new assessment action based at least in part on the vehicle condition, vehicle symptoms, feedback data, and/or the like.

At operation 739, the apparatus 200 optionally includes means such as the model circuitry 209, the mitigation circuitry 211, the communications circuitry 205, the input/output circuitry 207, the processor 201, and/or the like, or a combination thereof, that obtain approval for the new corrective action. For example, the apparatus 200 may obtain approval for the corrective action from one or more computing devices 105, the knowledge management environment 106, and/or the like. The approval may embody consent to provision the new corrective action to a computing device 105 of a vehicle maintainer, vehicle operator, and/or the like. For example, the apparatus 200 may provision a new corrective action to an administrator computing device 105 to enable the administrator to review and approve or disapprove outputting of the new corrective action to a computing device 105 of a vehicle maintainer. As another example, the apparatus 200 may generate and provision to the knowledge management environment 106 a novelty learning loop log based at least in part on the new corrective action. In doing so, the apparatus 200 may cause the knowledge management environment 106 to update a fault model based at least in part on the new corrective action and/or relay the corrective action to one or more computing devices 105 for approval.

In various embodiments, in response to receiving an approval of the corrective action from the administrator computing device, the process 700 proceeds to operation 721 by which the apparatus 200 may output the new corrective action to the computing device 105 of the vehicle maintainer, vehicle operator, and/or the like. Alternatively, in some embodiments, the process 700 proceeds to operation 718 by which the apparatus 200 may generate an additional natural language output based at least in part on the new corrective action. In such contexts, the apparatus 200 may subsequently output the additional natural language output to the computing device. Additionally, or alternatively, in some embodiments, the apparatus 200 may provision a new assessment action to one or more computing devices 105, the knowledge management environment 106, and/or the like. For example, the apparatus 200 may provision the new assessment action to a computing device 105 associated with an administrator, a computing device 105 associated with a system engineer, and/or the like, for approval. In response to receiving approval, the apparatus 200 may provision the new assessment action to a computing device 105 of a vehicle maintainer, vehicle operator, and/or the like. As another example, the apparatus 200 may generate and provision to the knowledge management environment 106 a novelty learning loop log based at least in part on the new assessment action.

### Example Interfaces of the Disclosure

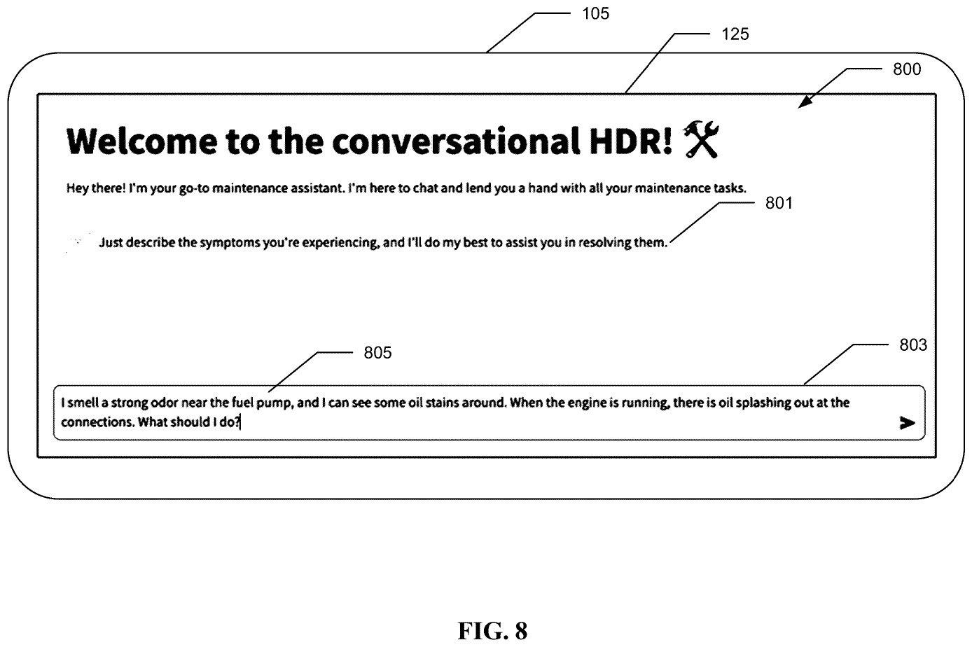

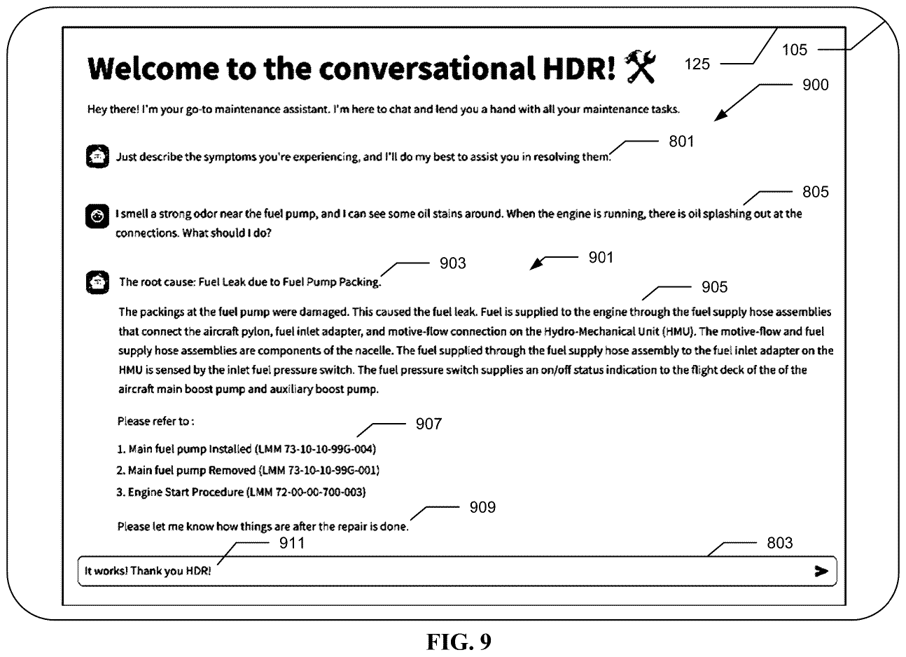

FIGS. 8 and 9 show example GUIs 800, 900 that may be rendered on a display 125 of a computing device 105. For example, the conversational maintenance system 103 may cause rendering of the GUIs 800, 900 on the display 125. In various embodiments, the GUIs 800, 900 demonstrate a conversational interaction between a vehicle maintainer and the conversational maintenance system 103 shown in FIG. 1 and described herein. For example, the GUIs 800, 900 may demonstrate data that is received from and provided to a vehicle maintainer during performance of the process 700 shown in FIG. 7 and described herein.

In some embodiments, the GUI 800 includes an instruction 801 configured to direct a user to submit a natural language input an input field 803. For example, the instruction 801 may instruct a user to describe their observations of vehicle symptoms, including visual observations, auditory observations, tactile observations, odor-based observations, and/or the like. The input field 803 may receive keystrokes, touch screen selections, and/or the like that are provided to an input device 127. Additionally, or alternatively, in some embodiments, the computing device 105 includes one or more recording systems configured to record utterance of natural language inputs, process the recording, and populate the input field 803 with natural language text generated based at least in part on the recording. The conversational maintenance system may receive the one or more natural language inputs 805 from the computing device 105. In some embodiments, the GUI 800, input field 803, and/or the like comprise a web interface, inline frame, and/or the like that enables the conversational maintenance system to directly collect and record natural language inputs 805 provided to the input field 803.

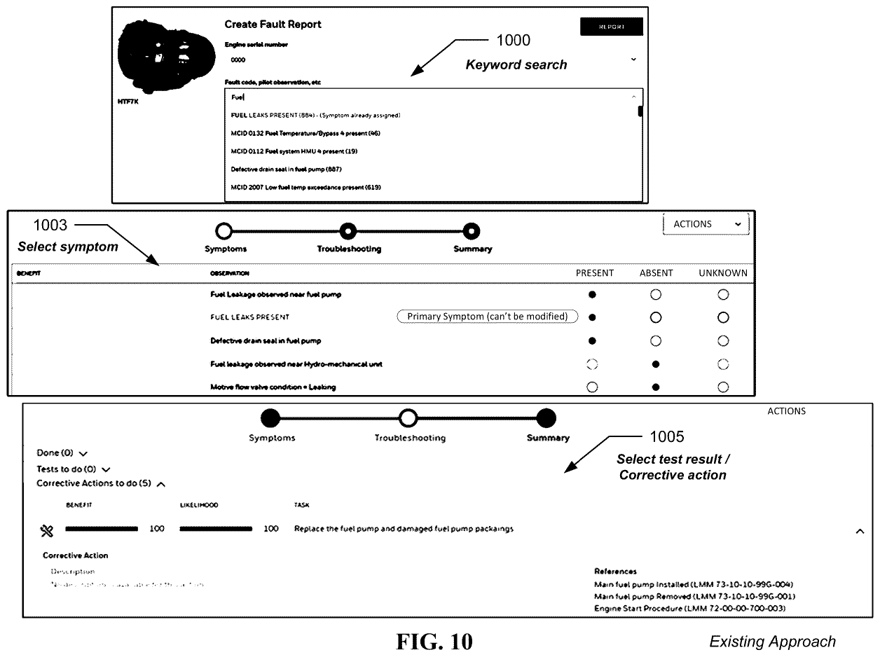

Existing approaches may be limited to receiving selections of keyword-based categories. For example, an existing approach may render an interface 1003 (FIG. 10) that limits users to selecting from a plurality of categories to indicate observed symptoms. In contrast, the input field 803 is configured to receive freeform text information, which may improve efficiency and specificity of intaking users' observations of vehicle issues. Further, the present techniques may enable a user to input additional considerations, requests, and/or the like via input field 803, such as questions (e.g., “what should I do?”), conditions (e.g., “when the engine is running”), or non-visual information (e.g., “I smell a strong odor”). In doing so, the present methods, apparatuses, and computer program products enable users to submit a greater depth and scope of information based upon which vehicle conditions and mitigation actions may be determined.

In various embodiments, the conversational maintenance system 103 performs processes described herein to generate a natural language instruction based at least in part on the natural language input 805 and generate one or more vehicle symptoms, vehicle conditions, and/or the like by inputting the natural language instruction to an LLM. The LLM may generate a vehicle symptom indicative of a vehicle condition based at least in part on the natural language instruction. For example, the conversational maintenance system 103 may receive a natural language input 805 comprising “I smell a strong odor near the fuel pump, and I can see some oil stains around. When the engine is running, there is oil splashing out at the connections. What should I do.?” In such contexts, the conversational maintenance system 103 may generate a natural language instruction comprising “Generate a most likely symptom and vehicle condition based on the following description; I smell a strong odor near the fuel pump, and I can see some oil stains around. When the engine is running, there is oil splashing out at the connections. What should I do.?”

In some embodiments, the conversational maintenance system 103 perform retrieval-augmented generation via the LLM and historical vehicle maintenance records obtained from one or more knowledge management environments. In some embodiments, the LLM generates a semantic representation, embedding, and/or the like of the natural language input. The conversational maintenance system 103 may compare the semantic representation to a plurality of semantic representations of historical vehicle maintenance records to determine a subset of the historical vehicle maintenance records that are within a threshold similarity of the vehicle symptom. The conversational maintenance system 103 may augment the first natural language instruction (or generate a new natural language instruction) based at least in part on the natural language input and subset of historical vehicle maintenance records (e.g., having identifiers x, y, z, etc.), and/or the like. For example, the conversational maintenance system 103 augment the example natural language instruction of the preceding paragraph to include “Generate a most likely symptom and vehicle condition based on the following description and historical vehicle maintenance records x, y, z; I smell a strong odor near the fuel pump, and I can see some oil stains around. When the engine is running, there is oil splashing out at the connections. What should I do?”

In some embodiments, via the LLM and natural language instruction, the conversational maintenance system 103 generates one or more symptoms indicative of a condition that is being experienced by the vehicle. For example, the LLM may generate a vehicle condition of “fuel leakage” and symptoms of detectable fuel odor, visible liquid accumulation, visible oil stains, and visible fuel emitting at connections. Additionally, the LLM may generate a root cause of the vehicle condition based at least in part on the observed symptoms of the natural language input, the generated vehicle symptoms, historical vehicle maintenance records, and/or the like. For example, the LLM may generate a root cause of “fuel leakage due to fuel pump packing.” Alternatively, the root cause of the vehicle condition may be determined by other means of the conversational maintenance system 103, such as one or more fault models. In some embodiments, the LLM generates a natural language output comprising the vehicle symptoms and indicated vehicle condition. For example, the LLM may generate a natural language output comprising “Based on the fuel odor, oil stains, and presence of fuel emissions at the connections, the vehicle is experiencing a fuel leak due to fuel pack pumping.” The conversational maintenance system 103 may cause rendering of the natural language output within the GUI being displayed on the computing device 105.

In various embodiments, based at least in part on the vehicle symptoms, condition, and/or the like that are generated by the LLM, conversational maintenance system 103 determines a corrective action that is most likely to result in successful mitigation of the vehicle condition. In some embodiments, the conversational maintenance system 103 generates a natural language instruction based at least in part on the corrective action. The conversational maintenance system 103 may generate the natural language instruction further based at least in part on the generated vehicle symptoms, condition root causes, historical vehicle maintenance records, and/or the like. For example, the second natural language instruction may comprise “Based on the following corrective action and symptoms, generate an explanation for how to mitigate the vehicle condition of fuel leakage due to fuel pump packing . . . ” The conversational maintenance system 103 may generate, via the LLM and based at least in part on the natural language instruction, a natural language output 901.

As shown in FIG. 9, the conversational maintenance system 103 may cause rendering of the natural language output 901 within the GUI 900. In various embodiments, the natural language output 901 includes a root cause 903 of the user's observations and symptoms generated by the LLM. For example, the root cause 903 may be “fuel leak due to fuel pump packing.” In some embodiments, the natural language output 901 comprises a narrative 905 configured to explain the root cause 903 of the vehicle condition in the context of the observations and LLM-generated symptoms. For example, the narrative 905 may describe faults or deficiencies of vehicle components that may result in the vehicle condition. As another example, the narrative 905 may define respective functions of vehicle components and processes associated with the vehicle condition. In various embodiments, the natural language output 901 includes one or more corrective actions for mitigating the vehicle condition as determined by the conversational maintenance system 103. In embodiments, the natural language output 901 includes respective identifiers 907 for the one or more corrective actions.

In some embodiments, the natural language output includes one or more instructions 909 for directing subsequent interactions between the user and the conversational maintenance system 103. For example, the instruction 909 may direct a user to provide feedback indicative of a level of success in mitigating the vehicle condition via implementation of the corrective action. As another example, the instruction 909 may direct a user to provide a result of an assessment action (e.g., based upon which additional assessment actions, corrective actions, and/or the like may be determined). In various embodiments, the input field 803 is configured to receive user inputs indicative of a result of mitigation actions, such as a level of mitigation success in accordance with implementation of a corrective action or a result of an assessment action. For example, in response to the natural language output 901, the input field 803 may receive a user input of “It works,” which may indicate that implementation of the corrective action successfully mitigated the vehicle condition.

In some embodiments, the conversational maintenance system 103 generates feedback data based at least in part on the user input and conversational history (e.g., mitigation actions, natural language outputs, generated symptoms, vehicle conditions, inputted observations, and/or the like). The conversational maintenance system 103 may update the LLM based at least in part on the feedback data. Additionally, or alternatively, the conversational maintenance system 103 may generate and store one or more maintenance records based at least in part on the feedback. For example, the conversational maintenance system 103 may generate a maintenance record and provision the maintenance record to a knowledge management environment. In doing so, the conversational maintenance system 103 may enable subsequent maintenance processes and LLM operations to exploit an expanding knowledge base of maintenance information drawn from a plurality of conversational interactions between users and one or more versions of the LLM.

Additionally, the conversational maintenance system 103 may preserve on the GUI 900 a conversational history comprising the instruction 801 and natural language input 805. In doing so, the conversational maintenance system 103 may preserve contextual information of the troubleshooting steps. Existing approaches typically direct a user through multiple different interfaces 1000, 1003, 1005, which may result in the user losing track of the submitted information. In contrast, the retention of inputs and outputs within a dynamically updated interface may provide a persistent and readily accessible overview of conversation-based maintenance troubleshooting.

### Conclusion

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method for corrective vehicle maintenance, comprising:
generating, using at least one query framework, a first natural language instruction based at least in part on a natural language input indicative of at least one observed vehicle symptom;
generating, via a large language model (LLM), at least one symptom of a vehicle condition based at least in part on the first natural language instruction;
determining at least one of a corrective action or an assessment action for mitigating the vehicle condition based at least in part on the at least one symptom;
generating a second natural language instruction based at least in part on the at least one symptom and the at least one of the corrective action or the assessment action;
generating, via the LLM, a natural language output based at least in part on the second natural language instruction; and
outputting the natural language output to at least one computing device.

2. The method of claim 1, wherein:
the at least one query framework comprises at least a first query framework associated with symptom identification and a second query framework associated with action identification; and
the method further comprises:
generating the first natural language instruction further based at least in part on the first query framework associated with symptom identification; and
generating the second natural language instruction further based at least in part on the second query framework associated with action identification.

3. The method of claim 1, further comprising:
outputting an utterance of the natural language output via a computer voice module of the at least one computing device.

4. The method of claim 1, further comprising:
causing rendering of a graphical user interface (GUI) on a display of the at least one computing device, the GUI comprising the natural language output.

5. The method of claim 4, wherein:
the GUI further comprises the at least one symptom of the vehicle condition.

6. The method of claim 1, further comprising:
obtaining an audio recording; and
generating the natural language input based at least in part on the audio recording.

7. The method of claim 1, further comprising:
obtaining image data of a vehicle associated with the at least one observed vehicle symptom; and
generating the first natural language instruction based at least in part on the image data.

8. The method of claim 1, further comprising:
generating a third natural language instruction based at least in part on a second natural language input indicative of a result of the assessment action;
generating, via the LLM, a second symptom based at least in part on the third natural language instruction; and
generating, via the LLM, a second natural language output based at least in part on a fourth natural language instruction comprising the at least one symptom and the second symptom, the second natural language output indicating a corrective action for mitigating the vehicle condition.

9. The method of claim 1, wherein:
the natural language output comprises the corrective action; and
the method further comprises:
in response to receiving a second natural language input indicative of a failure of mitigation in implementation of the corrective action, provisioning to the at least one computing device an instruction to provide an additional natural language input indicative of the at least one observed vehicle symptom;
generating a third natural language instruction based at least in part on the natural language output and an additional natural language input from the at least one computing device;
generating, via the LLM, a new corrective action based at least in part on the third natural language instruction;
provisioning the new corrective action to an administrator computing device; and
in response to receiving an approval from the administrator computing device, outputting to the at least one computing device a second natural language output indicative of the new corrective action.

10. The method of claim 9, further comprising:
provisioning the new corrective action to a knowledge management environment to cause the knowledge management environment to update at least one fault model based at least in part on the new corrective action.

11. The method of claim 1, wherein:
the natural language output comprises the corrective action; and
the method further comprises:
obtaining, from the at least one computing device, feedback data indicative of a level of success in mitigation of the vehicle condition by implementation of the corrective action; and
updating the LLM based at least in part on the feedback data.

12. An apparatus comprising at least one processor and at least one non-transitory memory having computer-coded instructions stored thereon that, in execution with at least one processor, cause the apparatus to:
generate, using at least one query framework a first natural language instruction based at least in part on a natural language input indicative of at least one observed vehicle symptom;
generate, via a large language model (LLM), at least one symptom of a vehicle condition based at least in part on the first natural language instruction;
determine at least one of a corrective action or an assessment action for mitigating the vehicle condition based at least in part on the at least one symptom;
generate a second natural language instruction based at least in part on the at least one symptom and the at least one of the corrective action or the assessment action;
generate, via the LLM, a natural language output based at least in part on the second natural language instruction; and
output the natural language output to at least one computing device.

13. The apparatus of claim 12, wherein:
the LLM is configured to generate a semantic representation of the at least one symptom of the vehicle condition; and
the instructions, in execution with the at least one processor, further cause the apparatus to:
determine the at least one of the corrective action or the assessment action based at least in part on the semantic representation.

14. The apparatus of claim 12, wherein:
the instructions, in execution with the at least one processor, further cause the apparatus to:
receive the natural language input from the at least one computing device via an application programming interface (API); and
provision the natural language output to the at least one computing device via the API.

15. The apparatus of claim 12, wherein:
the natural language output further comprises at least one root cause of the vehicle condition.

16. The apparatus of claim 12, wherein:
the instructions, in execution with the at least one processor, further cause the apparatus to:
generate respective semantic representations of a plurality of historical vehicle maintenance records;
generate a semantic representation of the natural language input;
determine a subset of the plurality of historical vehicle maintenance records for which the respective semantic representation is within a threshold similarity of the semantic representation of the natural language input; and
generate the first natural language instruction further based at least in part on the subset of the plurality of historical vehicle maintenance records.

17. The apparatus of claim 12, wherein:
the natural language output comprises the corrective action; and
the corrective action indicates:
at least one vehicle component; and
a respective replacement procedure for the at least one vehicle component.

18. The apparatus of claim 12, wherein:
the instructions, in execution with the at least one processor, further cause the apparatus to:
obtain feedback data from the at least one computing device, the feedback data being indicative of a level of success in mitigation of the vehicle condition by implementation of the corrective action; and
provision the feedback data to a knowledge management environment.

19. The apparatus of claim 12, wherein:
the natural language output comprises at least one image generated by the LLM based at least in part on the at least one of the corrective action or the assessment action; and
the instructions, in execution with the at least one processor, further cause the apparatus to:
cause rendering of the at least one image on a display of the at least one computing device.

20. A computer program product comprising at least one non-transitory computer-readable storage medium having computer program code stored thereon that, in execution with at least one processor, is configured to:
generate, using at least one query framework, a first natural language instruction based at least in part on a natural language input indicative of at least one observed vehicle symptom;
generate, via a large language model (LLM), at least one symptom of a vehicle condition based at least in part on the first natural language instruction;
determine at least one of a corrective action or an assessment action for mitigating the vehicle condition based at least in part on the at least one symptom;
generate a second natural language instruction based at least in part on the at least one symptom and the at least one of the corrective action or the assessment action;
generate, via the LLM, a natural language output based at least in part on the second natural language instruction; and
output the natural language output to at least one computing device.
